(19) United States
(12) Patent Application Publication
(10) Pub. No.: US 2008/0013545 A1
(43) Pub. Date: Jan. 17, 2008

(54) QoS CONTROL SYSTEM

(76) Inventors: Go Ono, Kokubunji (JP); Yukiko Takeda, Tokorozawa (JP); Kazuma Yumoto, Fuchu (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/773,833

(22) Filed: Jul. 5, 2007

(30) Foreign Application Priority Data
Jul. 13, 2006 (JP) 2006-192585

(51) Int. Cl. H04L 12/28

(52) U.S. Cl. 370/395.21

(57) ABSTRACT

In an access network linked to the core network that provides a service to a user equipment device, there is provided a QoS control system in which a QoS policy is decided based on the access type between user equipment device and the access network. The QoS control system for controlling allocation of the service comprises a QoS policy decision server deciding the policy of QoS to the requested service from the user equipment, an access gateway for connecting the access network and the core network. The QoS policy decision server decides the policy of QoS based on the type of access between the access network and the user equipment.

### CLAIM OF PRIORITY

The present application claims priority from Japanese application JP 2006-192585 filed on Jul. 13, 2006, the content of which is hereby incorporated by reference into this application.

### FIELD OF THE INVENTION

The present invention relates to QoS Control Systems in the network that accommodates multiple access types.

### BACKGROUND OF THE INVENTION

In recent years, the activity of shifting the existing telecommunication network to an IP (Internet Protocol) based network is progressing. In order to realize an IP based telecommunication network, ITU-T (International Telecommunication Union-Telecommunication Standardization sector) tackles standardization of an NGN (Next Generation Network). The NGN is a network basis for providing broad range of multimedia services based on the IP, and accommodates various kinds of access-types, such as an optical access, an ADSL, a third generation (3G) mobile phone, and a wireless LAN, and aims at constructing an architecture enabling to unite a fixed network and a mobile network.

Moreover, in the NGN the session control required for various multimedia services is provided by the IMS (IP Multimedia Subsystem). The IMS is a session control architecture of the multimedia service on the basis of an SIP (Session Initiation Protocol) as described in IETF RFC3261, SIP (Session Initiation Protocol) 2002/06. As for the IMS, standardization activity is proceeding by a 3GPP (3 rd Generation Partnership Project) and a 3GPP2 (3rd Generation Partnership Project2).

In the IMS, when a user equipment (UE) device establishes multimedia sessions (“session” in the following) with other UE device(s), an SIP message transmitted by one of the UE devices is processed and transmitted by a CSCF (Call Session Control Function), as described in 3GPP2 X.S0013-002-0 v1.0 (2004/02). The CSCF is an SIP server extended to the IMS. The CSCF is classified into a P-CSCF (Proxy-CSCF), an I-CSCF (Interrogating-CSCF), and an S-CSCF (Serving-CSCF). The P-CSCF is a CSCF that the UE device accesses first. The I-CSCF chooses a suitable S-CSCF for the received SIP message, and transmits the SIP message. The S-CSCF takes charge of the session control for the UE device and holds the session state.

Furthermore, the architecture of the QoS control for providing multimedia services is also discussed in the 3GPP2, as described in 3GPP2 X.S0013-012-0 v1.0 Draft Version 0.18.0. The functional entity called PCRF (Policy and Charging Control Function) is specified in the architecture of this QoS control, and the PCRF makes a policy decision for a QoS to the session. A QoS policy is the decision of an available resource quantity, a QoS class for the session, and approval or rejection to use resources, etc. In more details, the PCRF acquires the service information (a media type, a required band width) of a session from an AF (Application Function, corresponding to CSCF in IMS). The PCRF makes a policy decision for a QoS to be applied to a session based on service information and a LRBP (Local Resource Based Policy). The LRBP is information referenced in order to make a QoS policy decision in an access network. When receiving a resource request for resource use for the session from an AGW (Access Gateway) of the access network to which a UE device is connected, the PCRF responds to the resource request based on the decided QoS policy. The AGW performs a suitable QoS control to the session based on the reply from the PCRF. By applying the above architecture, the QoS control by the IMS can be performed on the session base. In addition, for such an architecture specifications of the interface between the AF and the PCRF and the interface between the PCRF and the AGW are required, that are discussed in 3GPP2 X.S0013-013-0 v1.0 Draft Version 0.5.0 and 3GPP2 X.S0013-014-0 v1.0 Draft of Version 0.2.0, respectively.

### SUMMARY OF THE INVENTION

In the QoS control architecture in the IMS of 3GPP and 3GPP2, the PCRF does not manage the type of access which is used in order for a UE device to be connected to the access network. However, in the NGN, the network configuration is assumed to accommodate various access-types, such as an optical access, an ADSL, a third generation (3G) mobile phone, and a wireless LAN, and, there is a possibility that a problem may arise when the current QoS control architecture is applied.

For example, in the current QoS control architecture, even in the case where a UE device is connected with either of a low band width wireless access-type or a broadband wireless access-type, the PCRF accepts the use of service consuming a lot of resources, such as a high-resolution video stream, if PCRF is configured to accept such services. Therefore, when the UE device is connected to the access point of a low band wireless access-type and uses the service consuming a lot of resources, there arises a possibility of exclusive possession of the band. Accordingly, at this time if another UE device is connected to the access point of the same low band wireless access-type, there is a possibility that the service cannot be started. On one hand, if the PCRF is configured to prohibit the use of service consuming a lot of resources, then exclusive possession of the band will not occur. However, on the other hand, a UE device is unable to use a service although it is connected by the broadband wireless access-type.

Therefore, in the NGN, a QoS control architecture is needed assuming a plurality of access types.

The present invention provides a QoS Control System wherein a QoS policy is decided based on the type of access which is used in order for a UE device to be connected to the access network, when the PCRF makes decision of the QoS policy. Moreover, the present invention provides the QoS Control System applicable also to either of 3GPP or 3GPP2.

In one of typical embodiments of the present invention, a QoS Control System controls the allocation of resources in the network wherein a user equipment device is connected via an access network to the core network providing services to control, and the QoS Control System comprises a QoS policy server making decision of a QoS policy to the service required by the user equipment device, and an access gateway connecting the access network and the core network, wherein the QoS policy server makes decision of the QoS policy based on the access-type connected to the access network for the user equipment device.

According to one of embodiments of the present invention, the QoS policy can be decided based on the access-type connecting the terminal and the access network.

### BRIEF EXPLANATION OF THE DRAWINGS

FIG. 1 shows a network configuration in accordance with a first embodiment of the present invention;

FIG. 2A is a block diagram showing the hardware configuration of a CSCF (Call Session Control Function) in accordance with a first embodiment of the present invention;

FIG. 2B is a block diagram showing the software configuration of the CSCF in accordance with a first embodiment of the present invention;

FIG. 3A is a block diagram showing the hardware configuration of a PCRF (Policy and Charging Control Function) in accordance with a first embodiment of the present invention;

FIG. 3B is a block diagram showing the software configuration of the PCRF in accordance with a first embodiment of the present invention;

FIG. 4A is a block diagram showing the hardware configuration of an AGW (Access Gateway) in accordance with a first embodiment of the present invention;

FIG. 4B is a block diagram showing the software configuration of the AGW in accordance with a first embodiment of the present invention;

FIG. 5 is a table structure showing a session information table in accordance with a first embodiment of the present invention;

FIG. 6A is a table structure showing a service information table in accordance with a first embodiment of the present invention;

FIG. 6B is a table structure showing an access type-QoS (Quality of Service) information table in accordance with a first embodiment of the present invention;

FIG. 7A is a table structure showing an Authorized QoS information table in accordance with a first embodiment of the present invention;

FIG. 7B is a table structure showing a Requested Access Network QoS information table in accordance with a first embodiment of the present invention;

FIG. 8 is an example of a packet showing an SIP (Session Initiation Protocol) INVITE message packet in accordance with a first embodiment of the present invention;

FIG. 9 is an example of a packet showing an SIP 183 reply message packet in accordance with a first embodiment of the present invention;

FIG. 10 is an example of a packet showing a service information notify packet (format in 720 and data in 720A), in accordance with a first embodiment of the present invention.

FIG. 11A is an example of a packet showing a resource request packet (format in 740 and data in 740A), in accordance with a first embodiment of the present invention;

FIG. 11B shows an example of a packet format for a resource reject packet or for a resource accept packet (format in 750 and data in 750A) in accordance with a first embodiment of the present invention;

FIG. 12A is a flow chart showing an SIP message program in accordance with a first embodiment of the present invention.

FIG. 12B is a flow chart showing a session information management program in accordance with a first embodiment of the present invention;

FIG. 13A is a flow chart showing a service information management program in accordance with a first embodiment of the present invention;

FIG. 13B is a flow chart showing a QoS policy decision program in accordance with a first embodiment of the present invention;

FIG. 14A is a flow chart showing a QoS information management program when a bearer establishment is started in accordance with a first embodiment of the present invention;

FIG. 14B is a flow chart showing a QoS information management program when a resource accept packet or a resource reject is received in accordance with a first embodiment of the present invention;

FIG. 15 shows an example of a sequence of a successful session establishment in accordance with a first embodiment of the present invention;

FIG. 16 shows an example of a sequence of a failed session establishment in accordance with a second embodiment of the present invention;

FIG. 17 shows an example of a sequence of a failed session establishment in accordance with a third embodiment of the present invention;

FIG. 18A is a table structure showing an access type-QoS information table in accordance with a fourth embodiment of the present invention;

FIG. 18B is a table structure showing an access type-QoS information table in accordance with a fifth embodiment of the present invention;

FIG. 18C is a table structure showing a service information table in accordance with a sixth embodiment of the present invention;

FIG. 19A is a table structure showing a service information table in accordance with a seventh embodiment of the present invention;

FIG. 19B is a table structure showing an access point QoS information table in accordance with a seventh embodiment of the present invention; and

FIG. 20 is a table structure showing an access point utilization situation table in accordance with an eighth embodiment of the present invention.

### DETAILED DESCRIPTION OF THE PREFERRED EMBODIMENTS

The embodiments of the present invention are explained based on the accompanying drawings in the following.

### First Embodiment

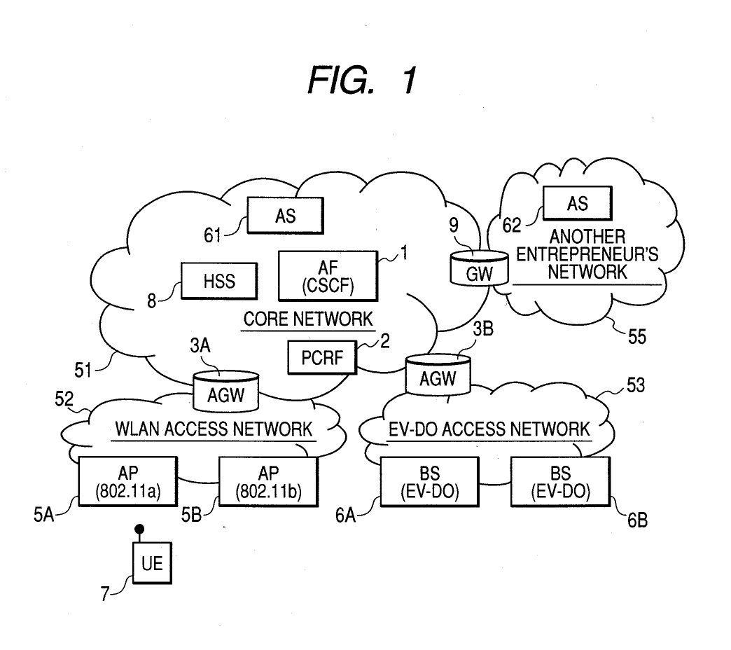

FIG. 1 shows the network configuration of the first embodiment of the present invention. In the first embodiment, a UE device is connected to an access point of IEEE802.11a and the procedure is explained of building a session of multimedia service.

In the network configuration of the first embodiment, connection with a wireless LAN is provided through a WLAN access network 52. And, connection by an EV-DO access is provided through an EV-DO access network 53.

The WLAN access network 52 accommodates an IEEE802.11a access point 5A (“AP” in the following), and an IEEE802.11b AP 5B. Whereas, the EV-DO access network 53 accommodates access points 6A and 6B for EV-DO (“BS” in the following). The WLAN access network 52 is connected to a core network 51 through an AGW 3A. And, the EV-DO access network 53 is connected to the core network 51 through an AGW 3B.

The core network 51 includes a CSCF 1, a PCRF 2, and a HSS (Home Subscriber Server) 8.

The CSCF 1 is an SIP server which receives an SIP message from a UE device 7 and transmits it to other servers. The PCRF2 is a policy decision server which makes decision of a QoS policy based on a service to provide. The HSS 8 manages a user's certification information, accounting information, position information, etc.

And, a network 55 owned by an entrepreneur different from a core network 51 owner is connected to the core network 51 through a GW (Gate Way) 9. Furthermore, the core network 51 includes an AS (Application Server) 61 for providing various multimedia services to a user. Similarly, the network 55 includes an AS 62.

The UE device 7 is connected to the WLAN access network 52 via the AP 5A or the AP 5B. Similarly, the UE device 7 is connected to the EV-DO access network 53 via the BS 6A or the BS 6B.

Next, the structure and operation are explained of the CSCF 1 of the first embodiment of the present invention.

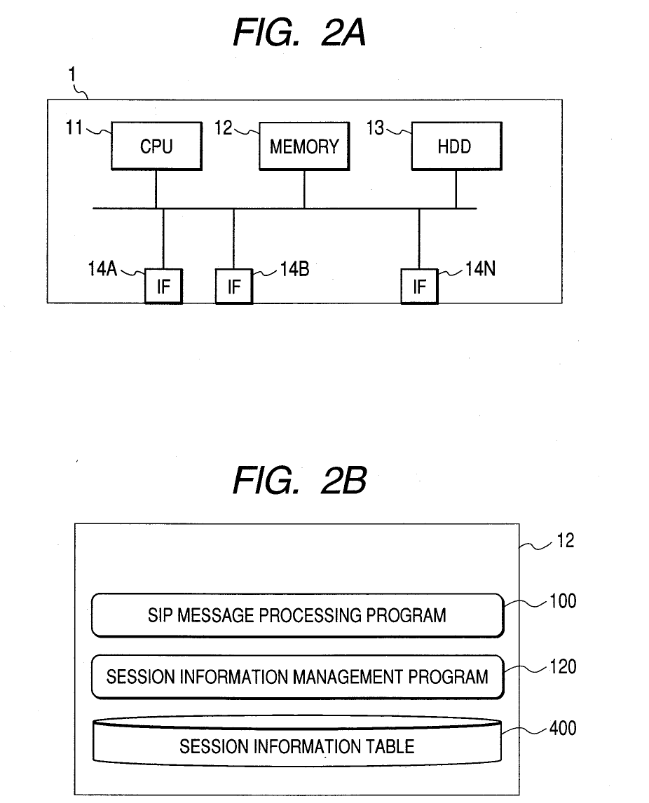

FIG. 2A shows the hardware configuration of the CSCF 1 of the first embodiment. The CSCF 1 has a CPU 11, a memory 12, a hard disk (“HDD” in the following) 13, and network interfaces (“IF” in the following) 14A-14N.

The CPU 11 executes the program stored in the memory 12. The Memory 12 stores programs and data required for processing to be performed by the CPU 11. The HDD 13 stores programs and data. The IF 14A-14N communicate with other computers through the core network 51.

FIG. 2B is shows the composition of the memory 12 of the CSCF 1 in the first embodiment. The memory 12 stores an SIP message processing program 100, a session information management program 120, and a session information table 400.

The SIP message processing program 100 and the session information management program 120 are executed by the CPU 11. The SIP message processing program 100 performs processing according to the SIP message received. The session information management program 120 updates the information on the session information table 400, and informs to the PCRF of the service information. The session information table 400 stores the SIP session information managed by the CSCF1.

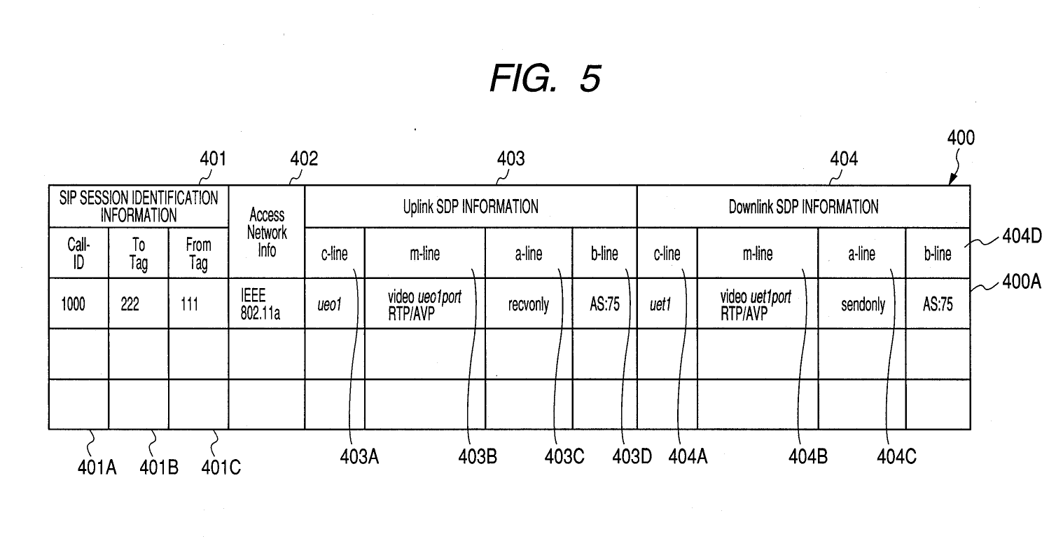

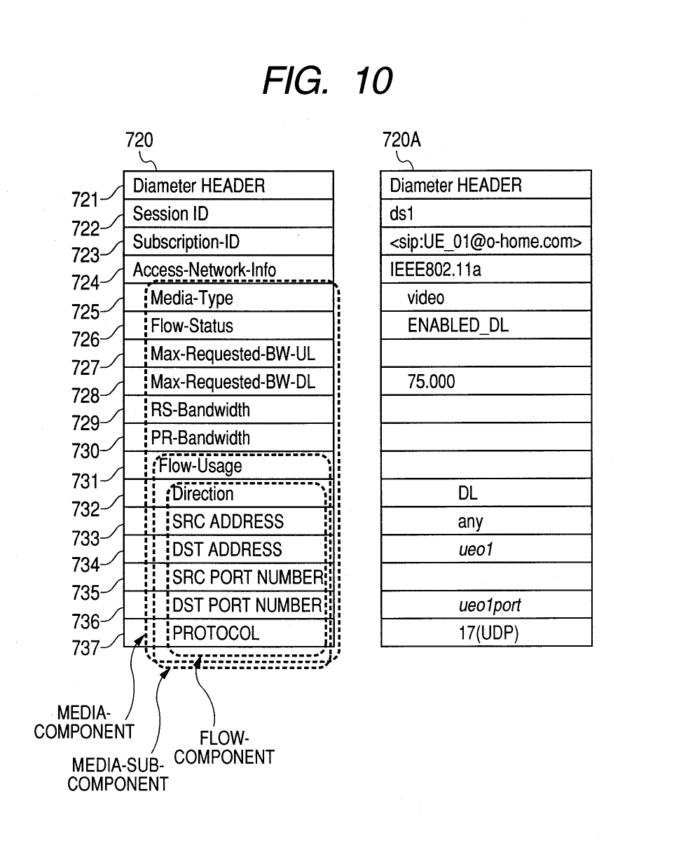

FIG. 5 shows the structure of the session information table 400 in the first embodiment. The session information table 400 is referred to in order that the session information management program 120 may generate a service information notify packet to be described later in FIG. 10. The CSCF 1 adds an entry to the session information table 400, whenever a new SIP session is established.

The session information tables 400 includes a SIP session identification information 401, an access network Info field 402, an Uplink SDP information field 403, and a Downlink SDP information field 404.

The SIP session identification information 401 is an identifier specifying the session of SIP that the CSCF 1 manages. The SIP session identification information 401 includes a Call-ID field 401A, a To Tag field 401B, and a From Tag field 401C. The Call-ID field 401A stores the identifier which is used to identify a SIP dialog uniquely. The To Tag field 401B stores a tag which identifies a recipient. The tag which identifies a source is stored in the From Tag field 401C.

The Access Network Info field 402 stores the type of access which is used in order for the UE device 7 to be connected to the access network.

The Uplink SDP information field 403 is the SDP (Session Description Protocol) information on the flow of an Uplink (the direction of UE device 7 to the AGW 3A). The SDP is a protocol that specifies the format of the text format for describing multimedia session information, including a connection time and the type of encoding, etc. The Uplink SDP information field 403 includes a c-line field 403A, an m-line field 403B, an a-line field 403C, and a b-line field 403D. The c-line field 403A stores connection information. The m-line field 403B stores media information. The a-line field 403C stores attribution information. The b-line field 403D stores bandwidth information.

The Downlink SDP information field 404 is the SDP information on the flow of a Downlink (the direction of UE device 7 from the AGW 3A). The Downlink SDP information field 404 includes a c-line field 404A, an m-line field 404B, an a-line field 404C, and a b-line field 404D. The c-line field 404A stores connection information. The m-line field 404B stores media information. The a-line field 404C stores attribution information. The b-line field 404D stores bandwidth information.

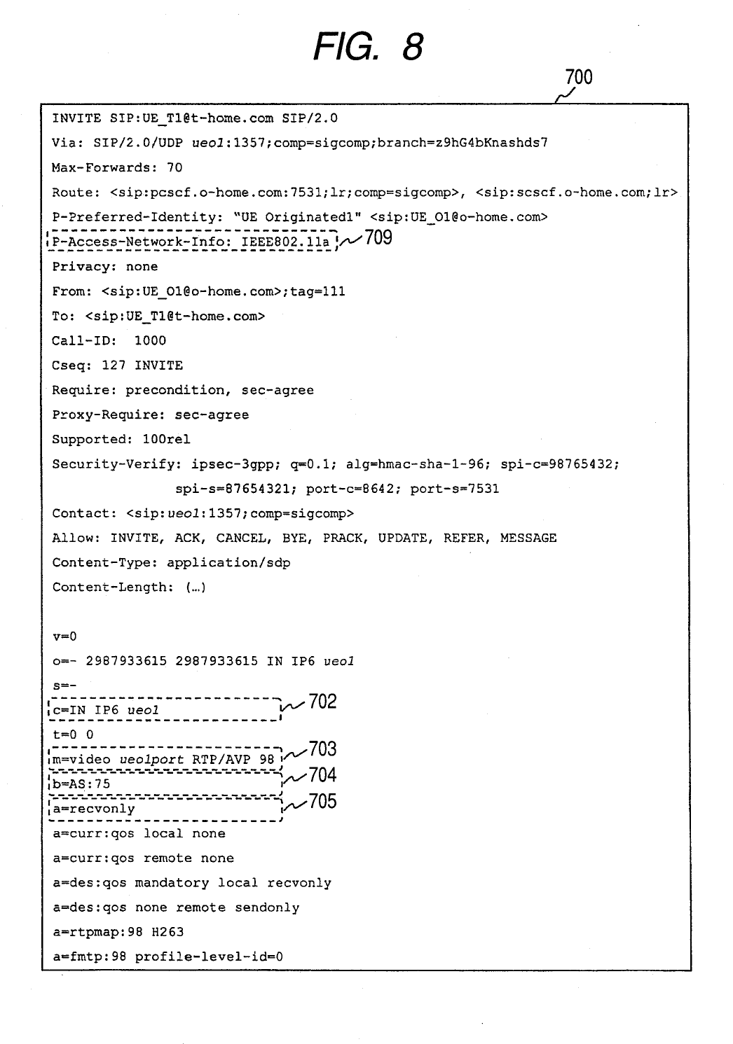

FIG. 8 shows a packet format of an SIP INVITE message 700 in the first embodiment. The packet of the SIP INVITE message 700 is transmitted to the CSCF 1 from the UE device 7, when starting a multimedia session. The CSCF 1 transmits a received packet to the user equipment of the partner.

The SDP is included in the SIP INVITE message 700. The information needed in order to add an entry to the session information table 400 is a P-Access-Network-Info header 709, and data included in the SDP, i.e., a c-line702, an m-line703, a b-line704, and information included in an a-line705 that shows the direction of the media flow.

The P-Access-Network-Info header 709 stores the type of access which is used in order for the UE device 7 to be connected to the access network. In the first embodiment, “IEEE802.11a” is stored in the P-Access-Network-Info header 709 as shown in FIG. 8. In this header, values such as “FTTH”, “Blue Tooth”, can be stored according to the access-type.

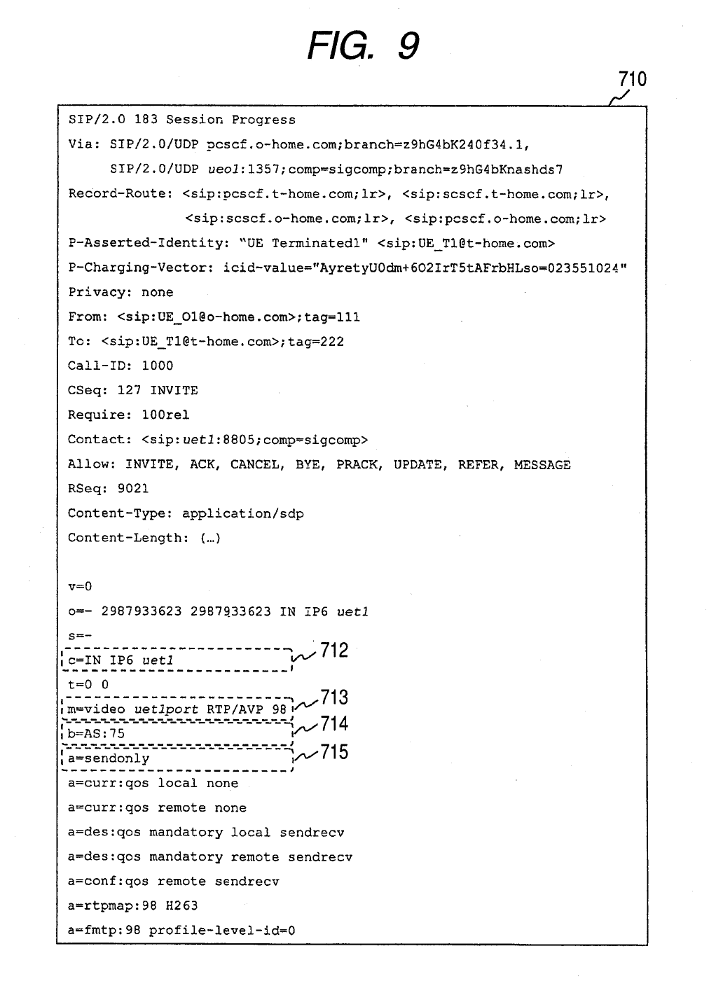

FIG. 9 shows a packet format of the SIP 183 reply message 710 in the first embodiment. The SIP 183 reply message 710 is a reply message to the SIP INVITE message 700 transmitted from the user equipment of the partner. The packet of the SIP 183 reply message 710 is transmitted from the user equipment of the partner, and then transmitted to the UE device 7 by the CSCF 1. An SDP is included in the SIP 183 reply message 710. The information needed in order to add an entry to the session information table 400 is contained in the SDP and these are a c-line712, an m-line713, a b-line714, and information included in an a-line715 that shows the direction of the media flow of the a-line.

FIG. 10 shows the structure of service information notify packet in the first embodiment. A numeral 720 shows the format of service information notify packet, and a numeral 720A shows an example of the data stored in service information notify packet. The service information notify packet is used in order that the CSCF 1 notifies the PCRF 2 of the information on a multimedia service newly built by the CSCF 1. In the first embodiment, the packet is exchanged in the Diameter protocol between the CSCF 1 and the PCRF 1.

The service information notify packet includes a Diameter header 721 and a Session ID field 722, and these fields are used for management of a Diameter session etc. A Subscription-ID field 723 stores an SIP URI etc. which shows the user information of UE device 7. An Access-Network-Info field 724 stores the type of access which is used in order for UE device 7 to be connected to the access network.

The fields 725-737 are components to show media information (media-component). Furthermore, a plurality of media-components may be contained in one service information notify packet. The Media-Type field 725 stores a classification of media type. The Flow-Status field 726 stores a state of flow. The fields 727-730 store bandwidth information required for the multimedia service to be used.

The Max-Requested-BW-UL field 727 and the Max-Requested-BW-DL field 728 store the information about the required bandwidth of Uplink and Downlink, respectively. The RS-Bandwidth field 729 and the RR-Bandwidth field 730 are used when the RTCP is utilized.

The fields 731-737 are components to show media sub information (media-sub-component). Furthermore, a plurality of media-sub-components may also be contained in one media-component. The Flow-Usage field 731 stores the value to show whether a flow is a RTCP flow or not.

The fields 732-737 are components to show flow information (flow-component), and may also contain a plurality of flow-components in one media-sub-component. The flow component includes the Direction field 732, the SRC address field 733, the DST address field 734, the SRC port number field 735, the DST port number field 736, and the protocol field 737.

The Direction field 732 stores the direction of a flow. The SRC address field 733 stores a source IP address. The DST address field 734 stores destination IP addresses. The SRC port number field 735 stores a source port number. The DST port number field 736 stores a destination port number. The protocol field 737 stores a protocol number or a protocol name.

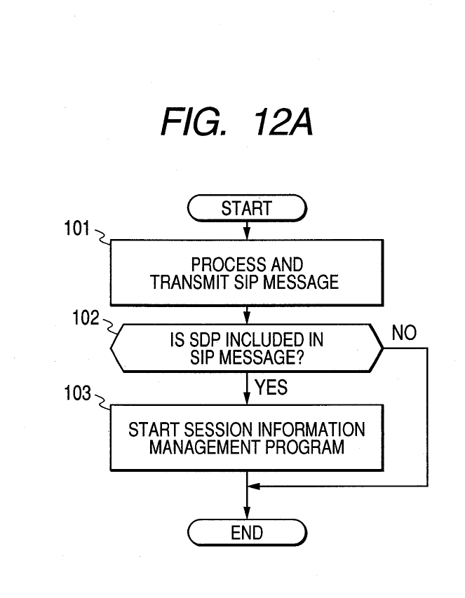

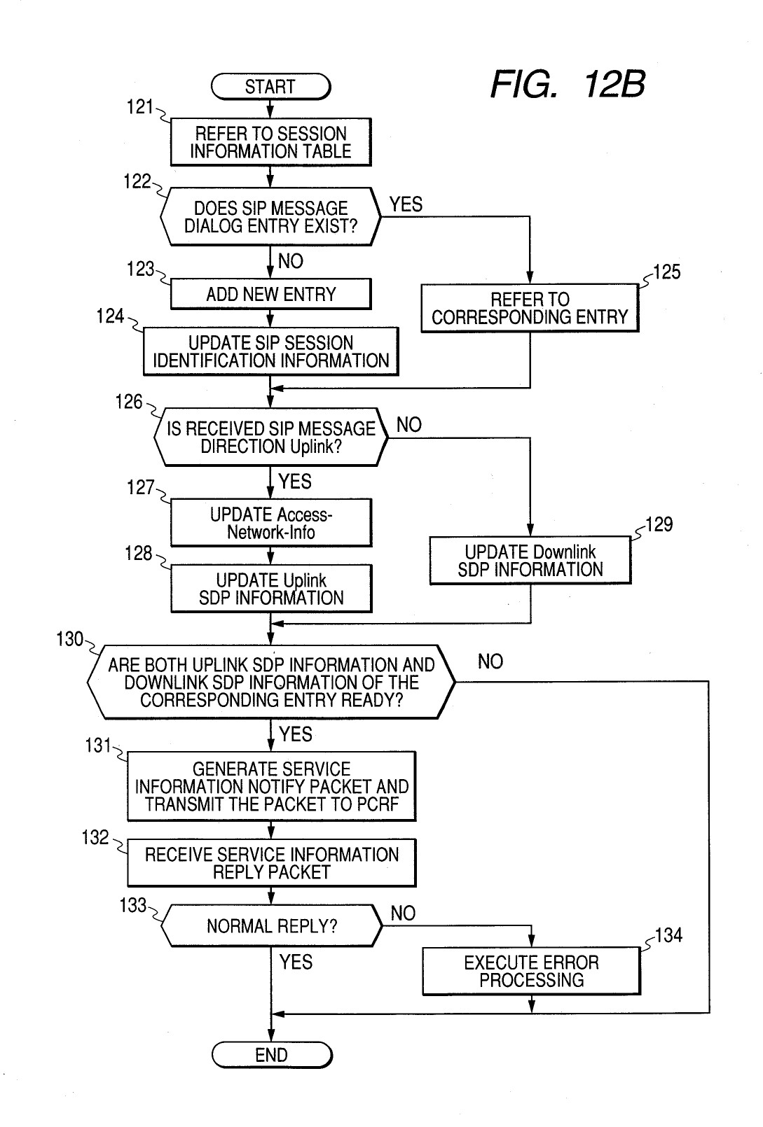

FIG. 12A is a flow chart showing the procedure of the SIP message processing program 100 in the first embodiment. The SIP message processing program 100 is started whenever it receives the SIP message.

The CSCF 1 executes processing according to the SIP message received (101). Specifically, according to the request SIP message or updates session information, etc.

Then, the CSCF 1 judges whether the SDP is contained in the received SIP message (102). The SDP is contained in the INVITE request messages from a source, or the reply message to the INVITE (FIG. 9). Therefore, the CSCF1 starts the session information management program 120 (103), when the received SIP message is an INVITE request message or a reply to the INVITE request message (the result of 102 is “YES”). The SIP message processing program 100 is then ended.

FIG. 12B is a flow chart showing the procedure of the session information management program 120 in the first embodiment. The session information management program 120 is executed by the CSCF 1.

The CSCF 1 first refers to the session information table 400 (121). Next, the CSCF 1 judges whether the entry of the session exists or not corresponding to the received SIP message based on the SIP session identification information 401 (122).

When the session corresponding to the session information table 400 does not exist (the result of 122 is “NO”), the CSCF1 adds a new entry (123) and updates the SIP session identification information 401 on the added entry (124). Meanwhile, when the session corresponding to the session information table 400 exists (the result of 122 is “YES”), the CSCF1 refers to the entry (125).

The CSCF 1 then judges the direction of the SIP message, whether Uplink or Downlink (126). When the direction of an SIP message is Uplink (the result of 126 “YES”), the CSCF 1 stores the value of the P-Access-Network-Info header 709 of the SIP message 700 in the Access Network Info field 402 of the session information table 400 (127). In addition, the value to be stored in the Access Network Info field 402 may also be decided according to the layer of the network connected, for example, a physical layer, or a data link layer based on the P-Access-Network-Info header 709. Furthermore, the CSCF 1 stores the SDP information on the SIP message 700 in the Uplink SDP information field 403 of the session information table 400 (128). Specifically, the values of 702, 703, 704, and 705 which are contained in the SIP message of FIG. 8 are stored in the corresponding fields 403A, 403B, 403D, and 403C in the session information table 400 of FIG. 5, respectively.

Meanwhile, when the direction of an SIP message is Downlink (the result of 126 is “NO”),the CSCF 1 stores the SDP information of the SIP in the Downlink SDP information field 404 of the session information table 400 (129). Specifically, the values of 712, 713, 714, and 715 contained in the SIP message 710 of FIG. 9 are stored in the corresponding locations 404A, 404B, 404D, and 404C in the session information table 400 of FIG. 5, respectively.

Then, the CSCF 1 decides whether both the Uplink SDP information fields 403 and the Downlink SDP information fields 404 of the entry are set corresponding to the session (130). The fields 403 and 404 are also both set when the partner of the UE device receives the SIP INVITE message transmitted from the UE device 7, and transmits an SIP reply message to the UE device 7. The CSCF 1 ends the processing, when only one of the fields 403 and 404 is set (the result of 130 is “NO”).

The CSCF 1 generates the service information notify packet 720 (131), when both values are set for the Uplink SDP information field 403 and the Downlink SDP information field 404 of an entry corresponding to a session (the result of 130 is “YES”).

The service information notify packet 720 is generated based on the information stored in the session information table 400. Specifically, the value of Access Network Info field 402 of the session information table 400 is stored in the Access-Network-Info field 724 of the service information notify packet 720. The values stored in the Media-Type field 725 are generated based on the values stored in the m-line fields 403B and 404B. The values stored in the Flow-Status field 726 are generated based on the values stored in the a-line fields 403C and 404C.

The values stored in the bandwidth information fields 727-730 are generated based on the values stored in the b-line fields 403D and 404D. In addition, the Flow-Usage field 731 is not needed if media-sub is not the RTCP.

The values to be stored in the Direction field 732 are generated based on the values stored in the a-line fields 403C and 404C. The value to be stored in the SRC address field 733 is generated based on the value stored in the c-line field 403A. The value to be stored in the DST address field 734 is generated based on the value stored in the c-line field 404A. The value to be stored in the SRC port number field 735 is generated based on the value stored in the m-line field 403B. The value to be stored in the DST port number field 736 is generated based on the value stored in the m-line field 404B. The values to be stored in the protocol field 737 are generated based on the values stored in the m-line fields 403B and 404B. After the CSCF 1 generates the service information notify packet 720, it transmits the packet to the PCRF 1 (131).

Then, the CSCF 1 receives the service information reply packet which is the reply to the service information notify packet 720 (132). The CSCF 1 decides whether a service information reply packet is a normal reply or not (133). The CSCF 1 ends the session information management program 120, if the service information reply packet is a normal reply (the result of 133 is “YES”). When the service information reply packet is not a normal reply (the result of 133 is “No”), the CSCF 1 ends the session information management program 120 after an error processing execution (134).

Next, the structure and processing of the PCRF 2 in the first embodiment are explained.

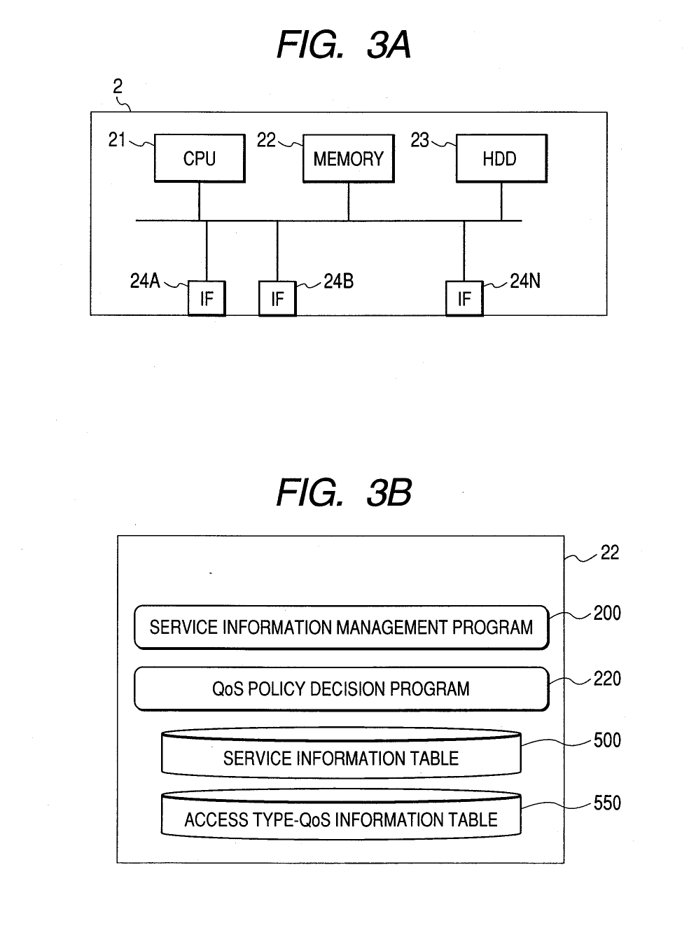

FIG. 3A shows the hardware configuration of the PCRF 2 in the first embodiment. The PCRF2 has a CPU21, a memory 22, a HDD23 and IF24A-24N.

The CPU 21 executes the program stored in the memory 22. The memory 22 stores the program to be executed by the CPU 21 and data required for the processing. The HDD 23 stores programs and data. The IF24A-24N communicate with other computers through the core network 51.

FIG. 3B shows the memory composition 22 of the PCRF 2 in the first embodiment. The memory 22 stores a service information management program 200, a QoS policy decision program 220, a service information table 500, and an access type-QoS information table 550.

The service information management program 200 and the QoS policy decision program 220 are executed by the CPU 21. The service information management program 200 adds an entry to the service information table 500 based on the service information notify packets 720 transmitted from the CSCF 1. The QoS policy decision program 220 makes decision of a QoS policy with reference to the service information table 500.

The service information table 500 stores the contents of the service information notify packet 720 transmitted by the CSCF 1. The access type-QoS information table 550 is referred to when the QoS policy decision program 220 makes decision of a QoS policy.

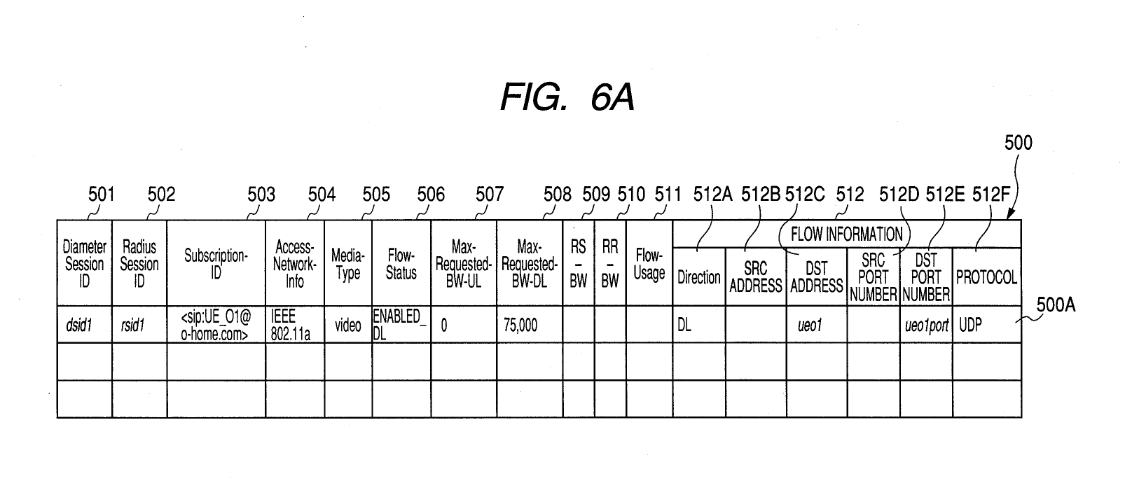

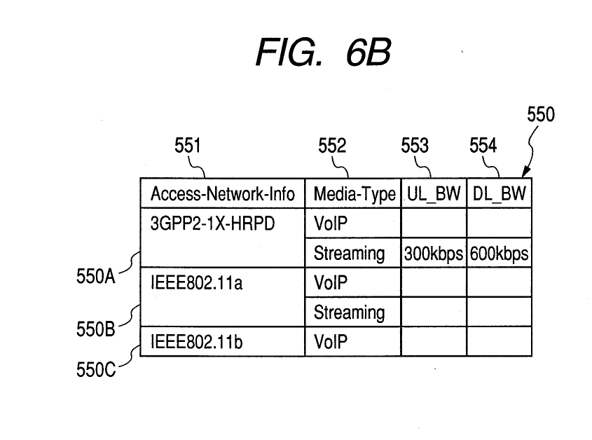

FIG. 6A shows the structure of service information table 500 in the first embodiment. The service information table 500 includes a Diameter Session ID field 501, a Radius Session ID field 502, a Subscription-ID field 503, an Access-Network-Info field 504, a Media-Type field 505, and a Flow-Status field 506. Furthermore, the service information table 500 includes fields 507-510 for storing bandwidth information, a Flow-Usage field 511, and a field 512 for storing flow information.

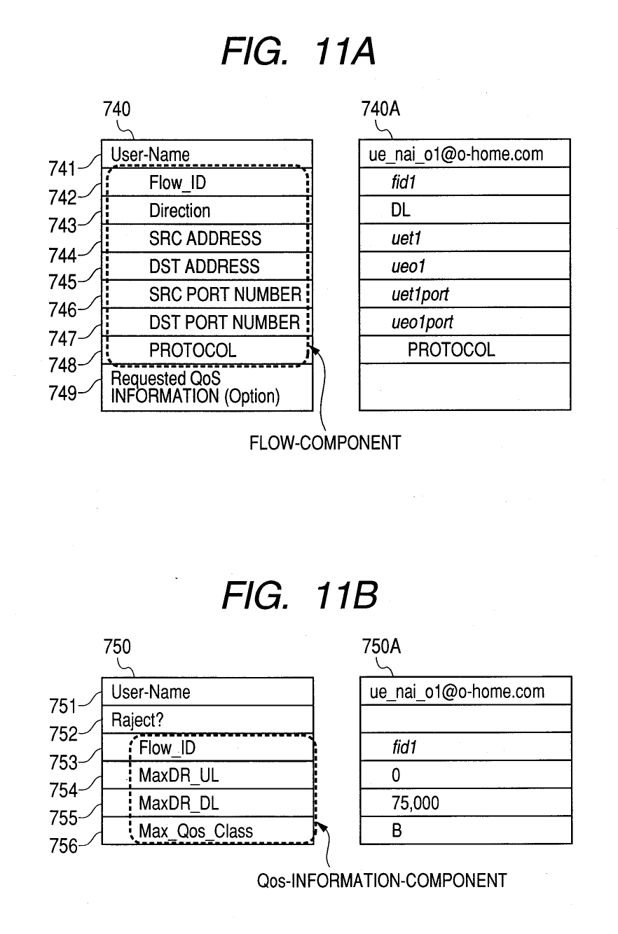

The Diameter Session ID field 501 stores a session identifier which exchanges the service information notify packet 720 between the CSCF 1 and the PCRF 2. The Radius Session ID field 502 is a session identifier which exchanges a resource request packet 740 to be mentioned later in FIG. 11A and a resource accept packet to be mentioned later in FIG. 11B between the PCRF 2 and the AGW 3A. The Subscription-ID field 503 stores an SIP URI etc. which shows the user information of the UE device 7. The Access-Network-Info field 504 stores the type of access which is used in order for the UE device 7 to be connected to the access network. The Media-Type field 505 stores the classification of a media type. The Flow-Status field 506 stores the state of a flow.

The fields 507-510 which store required bandwidth information include a Max-Requested-BW-UL field 507, a Max-Requested-BW-DL field 508, an RS-Bandwidth field 509, and an RR-Bandwidth field 510. The Max-Requested-BW-UL field 507 and the Max-Requested-BW-DL field 508 store the information about the required band widths for the Uplink and the Downlink, respectively. The RS-Bandwidth field 509 and the RR-Bandwidth field 510 are used when using the RTCP.

The Flow-Usage field 511 stores a value to show whether or not a flow is an RTCP flow. Specifically, the flow information field 512 includes a Direction field 512A, an SRC address field 512B, a DST address field 512C, an SRC port number field 512D, a DST port number field 512E, and a protocol field 512F.

The Direction field 512A stores the direction of a flow. The SRC address field 512B stores a source IP address. The DST address field 512C stores destination IP addresses. The SRC port number field 512D stores a source port number. The DST port number field 512E stores a destination port number. The protocol field 512F stores the protocol name of a flow.

FIG. 6B shows the structure of the access type-QoS information table 550 in the first embodiment. The access type-QoS information table 550 is set beforehand by a system administrator of an entrepreneur who provides an access network. The access type-QoS information table 550 may be set up as a part of the LRBP.

The access type-QoS information table 550 includes an Access-Network-Info field 551, a Media-Type field 552, a UL_BW field 553, and a DL_BW field 554.

The Access-Network-Info field 551 shows the type of access of target access networks. The Media-Type field 552 stores classification of target media types. The UL_BW field 553 stores the maximum band width the flow of Uplink is allowed to make use thereof. The DL_BW field 554 stores the maximum band width the flow of Downlink is allowed to make use thereof.

Moreover, the entry 550A for the 3GPP2-1 X-HRPD (EV-DO), the entry 550B for the IEEE802.11a, and the entry 550C for the IEEE802.11b are set in the access type-QoS information table 550 in the first embodiment. For example, when the UE device 7 uses an EV-DO as a access method, the maximum of the available bandwidth for the Uplink is 300 k bps, and for the Downlink is 600 k bps for the streaming service.

FIG. 11A shows the format of the resource request packet 740 in the first embodiment. The resource request packet 740 is a packet for the AGW 3A or AGW 3B to request to use resources from the PCRF 2 for the multimedia service which the UE device 7 is newly to start to use. In addition, using the Radius protocol the resource request packet 740 is exchanged between the AGW 3A and the PCRF 2 in the first embodiment.

The resource request packet 740 includes a User-Name field 741, fields 742-748 (flow-component) to show flow information, and a Requested QoS information field 749.

The User-Name field 741 stores an NAI (Network Access Identifier) to show a User Information of the UE device 7.

The fields 742-748 constituting the flow-component may contain a plurality of flow-components in one resource request packet 740. The flow-component includes a flow ID field 742, a Direction field 743, an SRC address field 744, a DST address field 745, an SRC port number field 746, a DST port number field 747, and a protocol field 748.

The Flow ID field 742 stores an identifier for identifying a flow. The Direction field 743 stores the direction of a flow. The SRC address field 744 stores a source IP address. The DST address field 745 stores destination IP addresses. The SRC port number field 746 stores a source port number. The DST port number field 747 stores a destination port number. The protocol field 748 stores the name or number of a protocol used for communication.

The Requested QoS information field 749 is used when supplying the PCRF 2 with the QoS information which is needed for the AGW 3A to start a multimedia session. In addition, the Requested QoS information field 749 is an option, so that the Requested QoS information field 749 may not be included in the resource request packet 740 depending on circumstances.

FIG. 11B shows the format 750 for a resource accept packet, and also for a resource reject packet in the first embodiment. The resource accept packet is a packet transmitted by the PCRF 2 to the AGW 3A or the AGW 3B as a reply to the resource request packet 740. The resource accept packet is a packet to notify assignable resource information to the multimedia service which the UE device 7 is newly going to start. Meanwhile, the resource reject packet is a packet for the PCRF 2 to notify the AGW 3A or the AGW 3B that a resource allocation is refused to the multimedia service which the UE device 7 is newly going to start.

The resource accept packet 750 includes a User-Name field 751, a Reject? field 752, and fields 753-756 to show QoS information (QoS-information-component).

The User-Name field 751 stores the NAI etc. to show user information of the UE device 7.

The Reject? field 752 is included only in the resource reject packet 750. That is, distinction between a resource accept packet and a resource reject packet is decided by the existence of the Reject? field 752.

A QoS-information-component includes a Flow_ID field 753, a MaxDR_UL field 754, a MaxDR_DL field 755, and a Max_QoS_Class field 756. A plurality of QoS-information-components may be included in one resource accept packet.

In addition, the resource reject packet is the same as that of a resource accept packet except for including the Reject? field 752. The resource reject packet does not necessarily need to include a QoS-information-component.

The Flow_ID field 753 stores an identifier for identifying a flow. The MaxDR_UL field 754 stores the value of data rate approved to the Uplink of a flow. The value of the data rate approved to the Downlink of a flow is stored in the MaxDR_DL field 755. The Max_QoS_Class field 756 stores the QoS class approved to the flow.

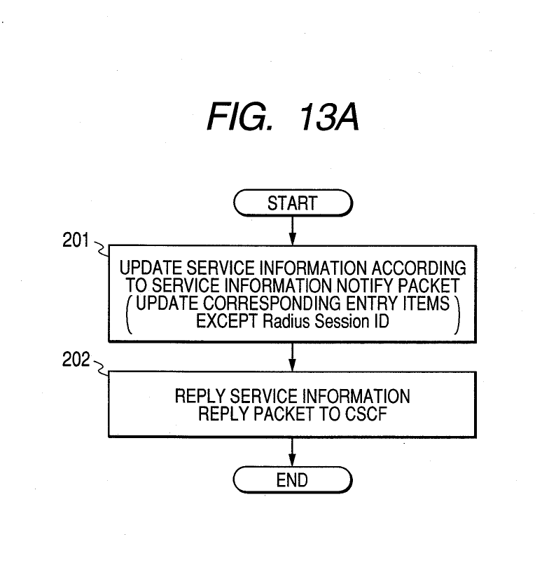

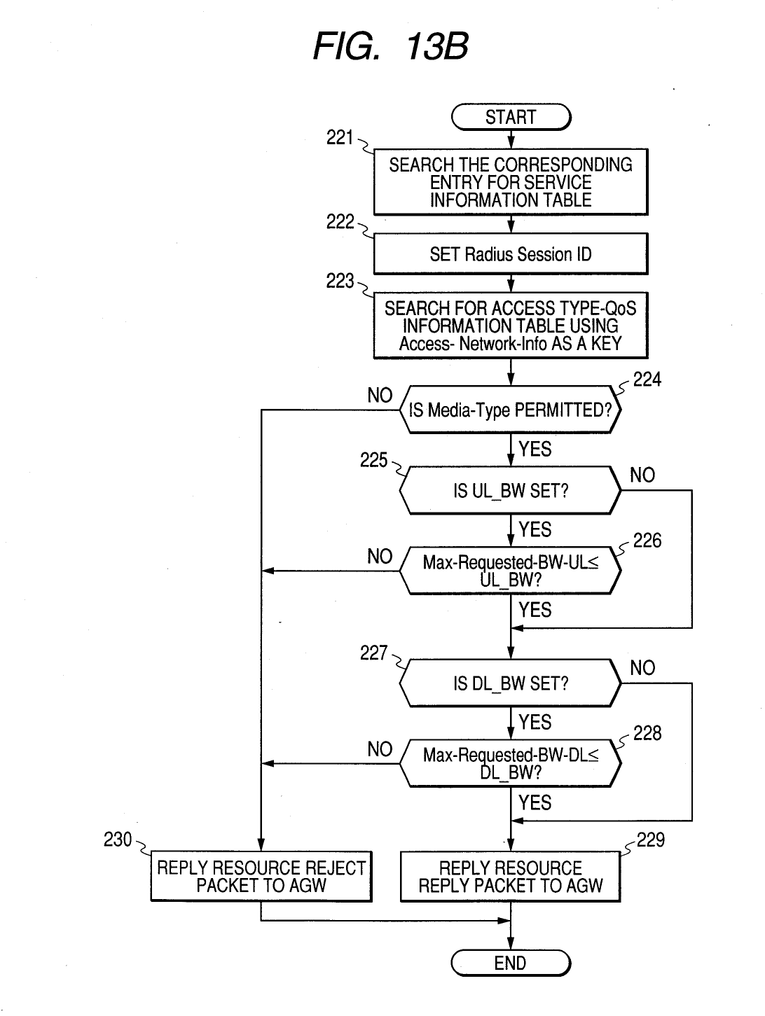

FIG. 13A is a flow chart showing the procedure of the service information management program 200 in the first embodiment. The service information management program 200 is executed by the PCRF 2 when the service information notify packet 720 is received.

Based on the received service information notify packet 720, the PCRF 2 adds a new entry to the service information table 500, and updates the fields except the Radius Session ID field 502 (201).

Specifically, the value of Session ID field 722 of the service information notify packet 720 is stored in the Diameter Session ID field 501 of the service information table 500. Similarly, the value of Subscription-ID field 723 is stored in the Subscription-ID field 503. The value of Access-Network-Info field 724 is stored in the Access-Network-Info field 504. The value of Media-Type field 725 is stored in the Media-Type field 505. The value of Flow-Status field 726 is stored in the Flow-Status field 506. The value of Max-Requested-BW-UL field 727 is stored in the Max-Requested-BW-UL field 507. The value of Max-Requested-BW-DL field 728 is stored in the Max-Requested-BW-DL field 508. The value of RS-Bandwidth field 729 is stored in the RS-BW field 509. The value of RR-Bandwidth field 730 is stored in the RR-BW field 510. The value of Flow-Usage field 731 is stored in the Flow-Usage field 511. The values of the flow-components (732-737) of the service information notify packet 720 are stored in the flow information field 512 (512A-512F).

Then, the PCRF 2 transmits a service information reply packet 740 to the CSCF 1 as a reply to the service information notify packet 720 (202), and ends the processing.

FIG. 13B is a flow chart showing the procedure of QoS policy decision program 220 in the first embodiment. The QoS policy decision program 220 is executed by the PCRF 2 when the resource request packet 740 is received.

When receiving the resource request packet 740, the PCRF 2 first refers to the service information table 500. The PCRF 2 searches for a corresponding entry based on the user information of the Subscription-ID field 503 and the User-Name field 741 of the resource request packet 740, or on the flow information 512 and the information of the flow-component of the resource request packet 740 (221).

Next, the PCRF 2 updates the Radius Session ID field 502 (222). Furthermore, the PCRF 2 acquires the entry corresponding to a session from the access type-QoS information table 550 based on the value of the Access-Network-Info field 504 (223).

The PCRF 2 decides whether the value stored in the Media-Type field 505 is approved based on the entry of the acquired access type-QoS information table 550 (224). When the media type is approved (the result of 224 is “YES”), the PCRF 2 decides whether a value is set or not in the UL_BW field 553 (225). When a value is set in the UL_BW field 553 (the result of 225 is “YES”), the PCRF 2 decides whether the value in the Max-Requested-BW-UL field 507 is equal to or below the value of the UL_BW field 553 (226). Furthermore, the PCRF 2 decides whether a value is set or not in the DL_BW field 554 (227). And when a value is set (the result of 227 is “YES”), the PCRF 2 decides whether the value in the Max-Requested-BW-DL field 508 is equal to or below the value of the DL_BW field 554 (228).

When the above conditions are satisfied, the PCRF 2 generates a resource accept packet based on the entry stored in the service information table 500, and transmits the packet to the AGW 3A (229), and ends the processing. However, when at least one of the conditions of 224, 226, and 228 is not satisfied, the PCRF 2 generates a resource reject packet, and transmits it to the AGW 3A (230), and ends the processing.

Next, the structure and processing of the AGW 3A are explained in the first embodiment. In addition, the structure of AGW 3B is the same as that of AGW 3A.

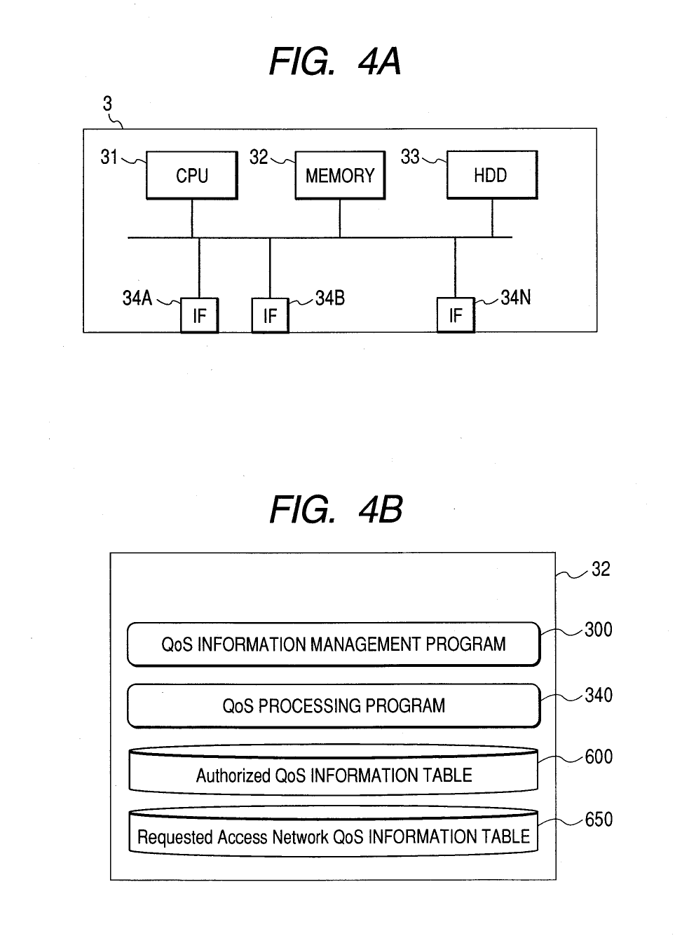

FIG. 4A shows the configuration of hardware of the AGW 3A in the first embodiment. The AGW 3A has a CPU31, a memory 32, a HDD33 and Ifs 34A-34N.

The CPU 31 executes the program stored in the memory 32. The Memory 32 stores programs and data required for executing and processing by the CPU 31. The HDD 33 stores the programs and data. The IFs 34A-34N communicate with other computers through the core network 51 or the access network 52.

FIG. 4B shows the structure of the memory 32 of AGW 3A in the first embodiment. The Memory 32 stores a QoS information management program 300, a QoS processing program 340, and an Authorized QoS information table 600 and a Requested Access Network QoS information table 650.

The QoS information management program 300 and the QoS processing program 340 are executed by the CPU 31. The QoS information management program 300 updates the Authorized QoS information table 600 and the Requested Access Network QoS information table 650, and transmit a resource request packet to the PCRF 2. The QoS processing program 340 executes QoS control based on the approved QoS policy.

The Authorized QoS information table 600 stores the content of the resource accept packet received from the PCRF 2. The Requested Access Network QoS information table 650 stores the QoS information requested in the process of a bearer establishment start between the UE device 7 and the AGW 3A.

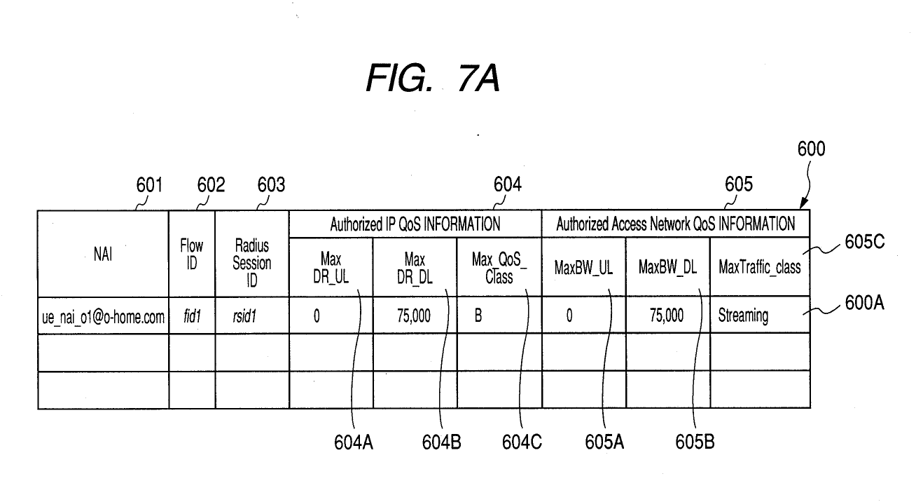

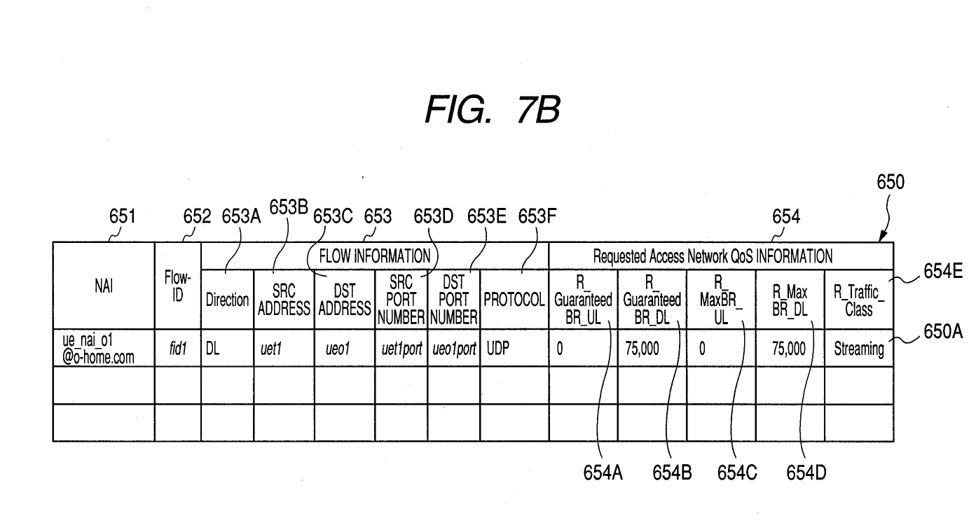

FIG. 7A shows the structure of the Authorized QoS information table 600 in the first embodiment. An entry is added to the Authorized QoS information table 600, whenever a bearer establishment is started between the UE device 7 and the AGW 3A.

The Authorized QoS information table 600 includes a NAI field 601, a Flow_ID field 602, a Radius Session ID field 603, an Authorized IP QoS information field 604, and an Authorized Access Network QoS information field 605.

The NAI field 601 stores a NAI to show user information of the UE device 7. The Flow_ID field 602 stores an identifier for identifying a flow. The Radius Session ID field 603 stores an identifier to identify a session, wherein the AGW 3A transmits a resource request packet 740 to the PCRF 2. The Authorized IP QoS information field 604 stores the values of the QoS-information-component (754-756) of the resource accept packet received from the PCRF 2.

The Authorized Access Network QoS information field 605 stores information for comparing with a Requested Access Network QoS information 654 to be mentioned later. The Authorized Access Network QoS information field 605 includes a MaxBW_UL field 605A, a MaxBW_DL field 605B, and a MaxTraffic_Class field 605C. The values stored in the Authorized Access Network QoS information field 605 are generated based on the information in the Authorized IP QoS information field 604.

FIG. 7B shows the structure of Requested Access Network QoS information table 650 in the first embodiment. An entry is added to the Requested Access Network QoS information table 650, whenever a bearer establishment is started between the UE device 7 and the AGW 3A.

The Requested Access Network QoS information table 650 includes a NAI field 651, a Flow_ID field 652, a flow information field 653, and a Requested Access Network QoS information field 654.

The NAI field 651 stores a NAI which shows user information of the UE device 7. The Flow_ID field 652 stores an identifier for identifying a flow.

The flow information field 653 stores flow information. The flow information field 653 includes a Direction field 653A, an SRC address field 653B, a DST address field 653C, an SRC port number field 653D, a DST port number field 653E, and a protocol field 653F. The Direction field 653A stores the direction of a flow. The SRC field 653B stores a source IP address. The DST address field 653C stores destination IP addresses. The SRC port number field 653D stores a source port number. The DST port number field 653E stores a destination port number. The protocol field 653F stores the name or number of a protocol.

The Requested Access Network QoS information field 654 stores QoS information requested when starting a bearer establishment. The Requested Access Network QoS information field 654 is compared with the Authorized Access Network QoS information field 605 of the Authorized QoS information table 600. Whether or not the bearer establishment is to be performed depends on the result of this comparison.

The Requested Access Network QoS information field 654 includes an R_GuaranteedBR_UL field 654A, an R_GuaranteedBR_DL field 654B, a R_MaxBR_UL field 654C, an R_MaxBR_DL field 654D, and an R_Traffic_Class field 654E.

The R_GuaranteedBR_UL field 654A stores a guaranteed bandwidth for transmitting data. The R_GuaranteedBR_DL field 654B stores a guaranteed bandwidth for receiving data. The R_MaxBR_UL field 654C stores the maximum band width for transmitting data.

The R_MaxBR_DL field 654D stores a maximum band width for receiving data. The R_Traffic_Class field 654E stores a requested kind of media.

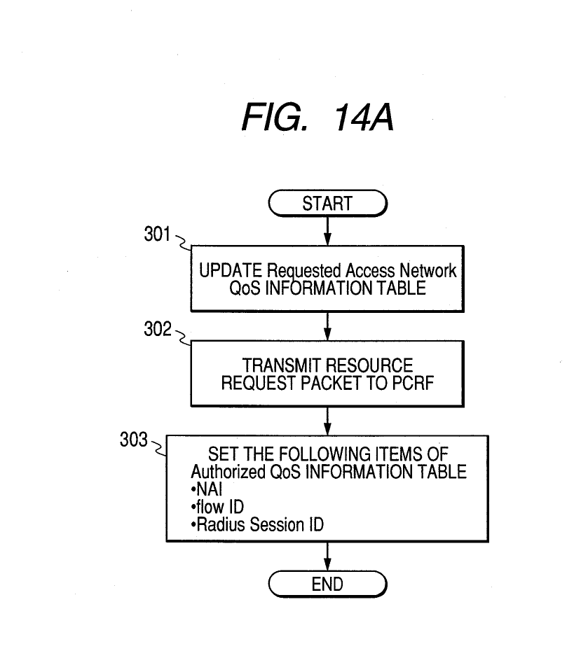

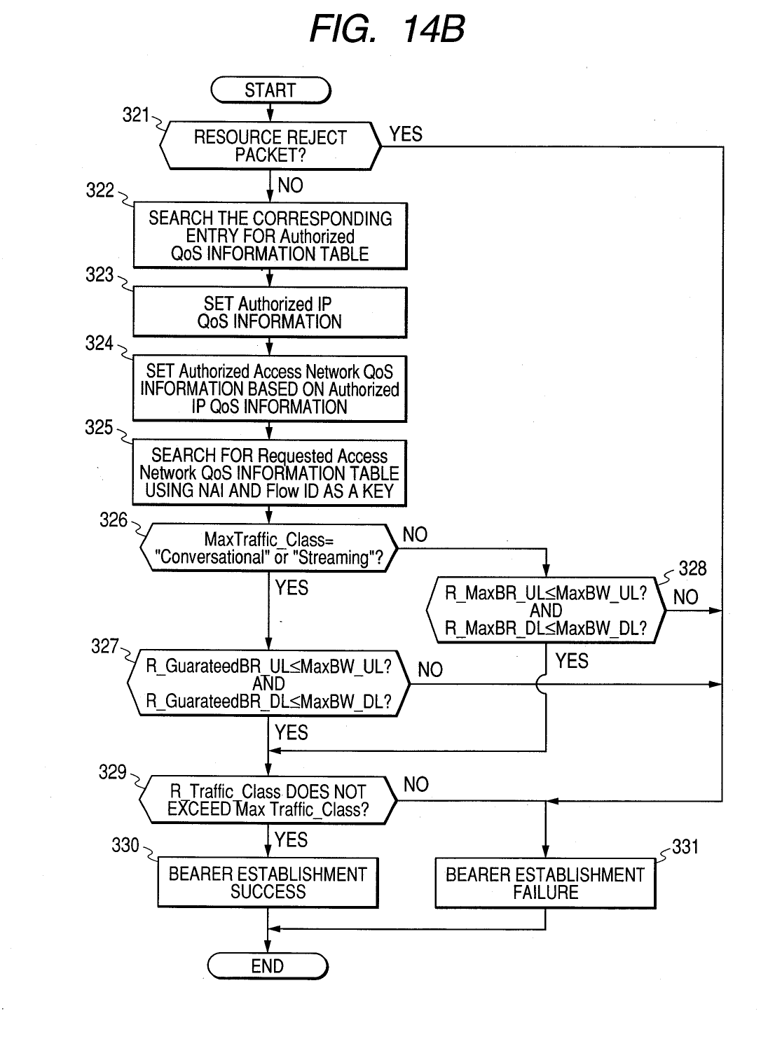

FIG. 14A is a flow chart showing the processing procedure for a bearer establishment by the QoS information management program 300 in the first embodiment.

The AGW 3A adds an entry to the Requested Access Network QoS information table 650 (301), based on the request to the bearer which the UE device 7 is going to establish.

Next, the AGW 3A generates a resource request packet 740, and transmits it to the PCRF 2 (302). In detail, the value of the NAI field 651 of the Requested Access Network QoS information table 650 shown in FIG. 7B is stored in the User-Name field 741 of the resource request packet 740 shown in FIG. 11A. Similarly, the value of the Flow_ID field 652 of the Requested Access Network QoS information table 650 is stored in the Flow_ID field 742 of the resource request packet 740. The values of the flow information field 653 (653A-653F) of the Requested Access Network QoS information table 650 are stored in the fields 743-748 of the resource request packet 740.

The AGW 3A adds a new entry to the Authorized QoS information table 600. And the AGW 3A sets the values of the NAI field 601, the Flow_ID field 602, and the Radius Session ID field 603 based on the contents of the resource accept packet transmitted from the PCRF 2 (303).

FIG. 14B is a flow chart showing the processing executed when the QoS information management program 300 receives a resource accept packet or a resource reject packet in the first embodiment.

The AGW 3A first decides whether the received packet is a resource reject packet or not (321). Specifically, it is decided whether a Reject? field 752 is included in the received packet. When the received packet does not include the Reject? field 752 (the result of 321 is “NO”), it means that the received packet is a resource accept packet, and the corresponding entry is searched and acquired from the Authorized QoS information table 600 (322).

Next, the AGW 3A sets the values of the Authorized IP QoS information entries 604 to the acquired entry (323). Specifically, the AGW 3A stores the value of the MaxDR_UL field 754 of the resource accept packet in the MaxDR_UL field 604A. Similarly, the AGW 3A stores the value of the MaxDR_DL field 755 in the MaxDR_DL field 604B, and the value of the Max_QoS_Class field 756 in the Max_QoS_Class field 604C.

Then, the AGW 3A sets the values of the Authorized Access Network QoS information field 605 based on the values of the Authorized IP QoS information field 604 (324). The value of the MaxDR_UL field 604A is stored in the MaxBW_UL field 605A. Similarly, the value of the MaxDR_DL field 604B is stored in the MaxBW_DL field 605B. The MaxTraffic_Class field 605C is set up based on the value of the Max_QoS_Class field 604C. For example, the QoS class expressed with signs, such as “A” or “B”, is converted into forms, such as “Conversational” or “Streaming”.

Next, the AGW 3A searches and acquires a corresponding entry from the Requested Access Network QoS information table 650 based on the values of the NAI field 601 and Flow_ID field 602 (325).

The AGW 3A decides whether the requested resource is not exceeding the accepted resource (326-329). Here, the requested resource is in the Requested Access Network QoS information field 654. And, the accepted resource is in the Authorized Access Network QoS information field 605.

The AGW 3A first decides whether the value of the MaxTraffic_Class field 605C agrees with either of “Conversational” or “Streaming” (326). On the one hand when there is an agreement (the result of 326 is “YES”), the AGW 3A then decides whether the value of the R_GuaranteedBR_UL field 654A is equal to or below the value of the MaxBW_UL field 605A and whether the value of the R_GuaranteedBR_DL field 654B is equal to or below the value of the MaxBW_DL field 605B (327). On the other hand, when there is not an agreement (the result of 326 is “NO”), the AGW 3A further decides whether the R_MaxBR_UL field 654C is equal to or below the value of the MaxBW_UL field 605A and whether the value of the R_MaxBR_DL field 654D is equal to or below the value of the MaxBW_DL field 605B (328).

When the processing result of 327 or 328 is “YES”, the AGW 3A decides whether the value of the R_Traffic_Class field 654E is not exceeding the value of the MaxTraffic_Class field 605C (329). If not exceeding (the result of 329 is “YES”), the bearer establishment is successful, which is notified to the UE device 7 (330).

When the requested resource exceeds the accepted resource (327-329), the bearer establishment is in failure, which is notified to the UE device 7, and a suitable error processing is performed if necessary (331). Moreover, also when the received packet is a resource reject packet (the result of 321 is “YES”), the bearer establishment is in failure, which is notified to the UE device 7, and a suitable error processing is performed if necessary (331).

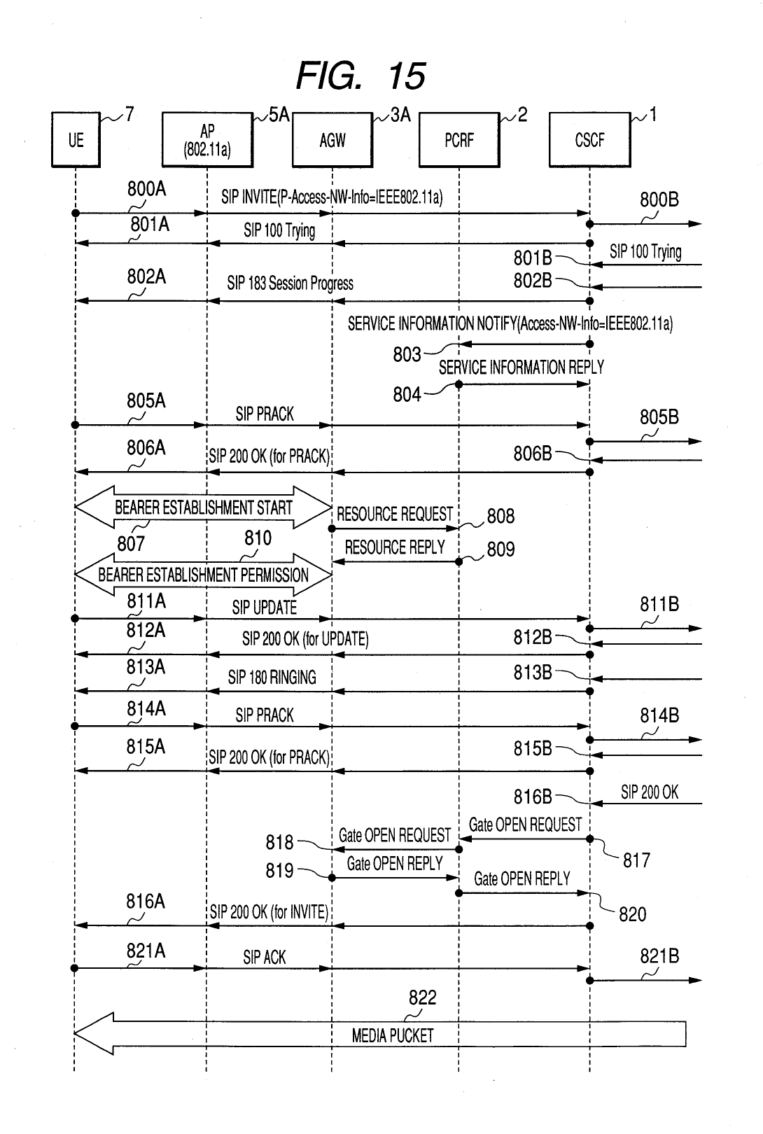

FIG. 15 shows the sequence of processing for establishing the session of the video stream media in the Downlink direction with the UE device 7 being connected to the AP 5A in the first embodiment. In this case, the establishment of this session is successful by using the access type-QoS information table 550 shown in FIG. 6B.

First, the UE device 7 transmits a SIP INVITE message to the CSCF 1 in order to establish a session (800A). In addition, since the UE device 7 is connected to the AP 5A of IEEE802.11a, the “IEEE802.11a” is set to the P-Access-Network-Info header 709 of a SIP INVITE message 700.

The CSCF 1 starts a session information management program 120 (103 of FIG. 12A), when the SIP INVITE message 700 is received (the result of 102 of FIG. 12A is “YES”). And the CSCF 1 adds a new entry 400A to a session information table 400 owned by itself (123 of FIG. 12B). At this time, the CSCF 1 copies the value stored in the P-Access-Network-Info header 709 in an Access-Network-Info field 402 (127 of FIG. 12B). Moreover, the CSCF 1 sets an Uplink SDP information field 403 based on the values of c-line702, m-line703, b-line704, and a-line705 which are included in the SIP INVITE message 700, (128 of FIG. 12B).

Moreover, the CSCF 1 transmits the SIP INVITE message 700 to a suitable destination (800B; 101 of FIG. 12A), and replies a SIP 100 reply message to the UE device 7 (801A).

And, the CSCF 1 receives a SIP 100 reply message from the destination (801B), and then also receives the SIP 183 reply message 710 from the destination (802B). Moreover, the SIP INVITE message 700 transmitted from the UE device 7 includes the candidates of the media corresponding to the required service. Receiving the SIP INVITE message 700, the user equipment of the partner chooses an available media out of the candidates of media, and stores it in the SIP 183 reply message 710, which is transmitted (802B). Therefore, a resource required for the requested service is determined after receiving the SIP 183 reply message 710.

When receiving the SIP 183 reply message 710, the CSCF 1 search for the corresponding entry 400A from the session information table 400 based on the SIP session identification information 401 (121 and 125 of FIG. 12B). And the CSCF 1 sets the Downlink SDP information field 404 based on the values of c-line712, m-line713 and b-line714, and a-line715 which are included in the SIP 183 reply message 710 (129 of FIG. 12B). And also, the CSCF 1 transmits the received SIP 183 reply message 710 to the UE device 7 (802A; 101 of FIG. 12A).

Furthermore, based on the corresponding entry 400A of the session information table 400, the CSCF 1 generates the service information notify packet 720A, which is transmitted to the PCRF 2 (803; 131 of FIG. 12B). In the Access-Network-Info field 724 of the service information notice packet 720A, “IEEE802.11a” is stored based on the Access-Network-Info field 402 of the corresponding entry 400A of the session information table 400.

Receiving the service information notify packet 720A (803), the PCRF 2 generates a new entry 500A in the service information table 500, and the values for each field of the entry 500A are set according to the corresponding values set in the service information notify packet 720A (201 of FIG. 13A). “IEEE802.11a” is stored in the Access-Network-Info field 504 of the entry 500A of the service information table 500. Then, the PCRF 2 transmits a service information reply packet to the CSCF 1 as a reply to the service information notify packet 720A (804; 202 of FIG. 13A).

Meanwhile, receiving the SIP 183 reply message 710, the UE 7 device transmits a SIP PRACK message in order to notify the confirmation of the receipt to the CSCF 1 (805A).

The CSCF 1 transmits the received SIP PRACK message to a suitable destination (805B; 101 of FIG. 12A). The CSCF 1 receives the SIP 200 reply message as a reply to the SIP PRACK message (806B), and transmits it to the UE device 7 (806A; 101 of FIG. 12A).

Meanwhile, the UE device 7 starts bearer establishment with the AGW 3A as usual (807), in parallel to transmission of the SIP PRACK message (805A).

The AGW 3A adds a new entry 650A to the Requested Access Network QoS information table 650, and sets the values for each field in the process of bearer establishment (301 of FIG. 14A). And based on the Entry 650A, the AGW 3A generates a resource request packet 740A, and transmits it to the PCRF 2 (808; 302 of FIG. 14A). Furthermore, the AGW 3A adds an entry 600A newly to the Authorized QoS information table 600, and sets the values of the NAI field 601, the Flow_ID field 602, and the Radius Session ID field 603 (303 of FIG. 14A).

Receiving the resource request packet 740A (808), the PCRF 21 searches for the corresponding entry 500A from the service information table 500, (221 of FIG. 13B). And the PCRF 2 searches for the corresponding entry 550B from the access type-QoS information table 550 based on the value “IEEE802.11a” stored in the Access-Network-Info field 504 (223 of FIG. 13B). Next, PCRF 2 decides whether or not to approve establishment of a session based on the values stored in the received resource request packet 740A (224-228 of FIG. 13B). In addition, establishment of a session is approved as mentioned above in the first embodiment. And the PCRF 2 generates a resource accept packet 750A and transmits it to the AGW 3A (809; 229 of FIG. 13B).

Receiving a resource accept packet 750A the AGW 3A updates the Authorized IP QoS information field 604 of the corresponding entry 600A of the Authorized QoS information table 600, based on the stored information (323 of FIG. 14B) And the AGW 3A deduces the values to be stored in the Authorized Access Network QoS information field 605 from the Authorized IP QOS information field 604, and stores them in the Authorized Access Network QoS information field 605 (324 of FIG. 14B). The AGW 3A decides whether the requested resource is available or not (326-329 of FIG. 14B). The bearer establishment is approved and the AGW 3A notifies that to the UE device 7 (810) in the first embodiment.

Then, the UE device 7 transmits a SIP UPDATE message to the CSCF 1 in order to complete session establishment (811A) The CSCF 1 transmits the received SIP UPDATE message to a suitable destination (811B). Then, the CSCF 1 receives a SIP 200 reply message as a reply to the SIPUPDATE message (812B), and transmits it to the UE device 7 (812A). Then, when the called user equipment begins to sound a ring tone, the CSCF 1 receives a SIP 180 reply (813B), and transmits it to the UE device 7 (813A). The UE device 7 receives the SIP 180 reply message (813A), and transmits the SIP PRACK message to the CSCF 1 (814A) to notify the receipt confirmation. The CSCF 1 transmits the received SIP PRACK message to a suitable destination (814B).

Then, the CSCF 1 receives a SIP 200 reply message (815B) as a reply to a SIP PRACK message (814B), and transmits the reply message to the UE device 7 (815A). Next, the CSCF 1 receives a SIP 200 reply message, when a called user answers (816B). The CSCF 1 transmits a Gate open request packet to the PCRF 2, in order to notify passage permission for the media packet to the AGW 3A, if the SIP 200 reply message is received from the called side (817).

The PCRF 2 transmits a Gate open request packet to the AGW 3A, when a Gate open request packet is received (818).

The AGW 3A permits the passage of media packet and, then transmits a Gate open reply packet to the PCRF 2 as a reply to the Gate open request packet (819). Furthermore, the PCRF 2 transmits a Gate open reply packet to the CSCF 1 (820).

The CSCF 1, receiving the Gate open reply packet, transmits the SIP 200 reply message received from the called side to the UE device 7 (816A). When receiving the SIP 200 reply message, the UE device 7 transmits a SIP ACK message to the CSCF 1 (821A). The CSCF 1 transmits the received SIP ACK message to a suitable destination (821B). And when the SIP ACK message reaches the called side user equipment, the establishment of a session is completed and exchange of a media packet is started (822).

The QoS policy based on the type of access between the UE device 7 and the access network can be decide by making the PCRF 2 recognize the type of access, according to the 1st embodiment of the present invention.

For example, it becomes possible to permit the use of service which consumes many resources, such as a video stream, only to the user equipment using a broadband access type. Therefore, it can prevent such a situation that other users can not receive a suitable service because a certain user connected to an access point with a low bandwidth consumes many resources. Moreover, stable services can be provided to users also for an entrepreneur who offers a service and for an entrepreneur who provides an access network.

### Second Embodiment

The UE device 7 is connected to the AP 5B of IEEE802.11b and establishes a session of the video stream media in the Downlink direction in the second embodiment. In addition, the same sign is used to denote a component to perform a similar function as in the first embodiment and the explanation thereof is abbreviated for simplicity. The second embodiment has the same configuration as that of the first embodiment except that the UE device 7 is connected to the AP 5B.

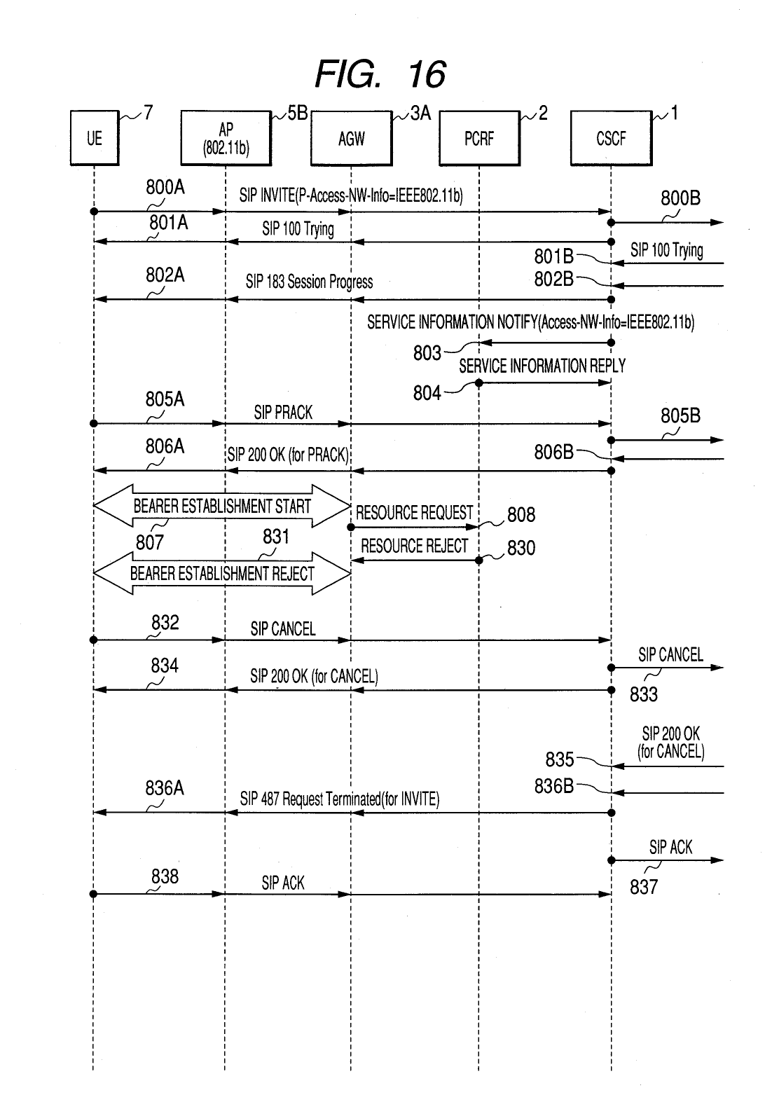

FIG. 16 shows the sequence of processing to establish the session of the video stream media in the Downlink direction in the second embodiment. In this case, according to the access type-QoS information table 550 shown in FIG. 6B, the establishment of this session fails.

The UE device 7 transmits a SIP INVITE message to the CSCF 1 as in the first embodiment first (800A). However, since the UE device 7 is connected to the AP 5B of IEEE802.11b in the second embodiment, the P-Access-Network-Info header 709 included in the SIP INVITE message 700 is set to “IEEE802.11b.” Therefore, “IEEE802.11b” is stored in the Access-Network-Info field 402 of the session information table 400.

Next, the UE device 7 receives the SIP 183 reply message as a reply to the SIP INVITE message (802A). Moreover, based on the entry to which the session information table 400 corresponds, the CSCF 1 generates the service information notify packets 720, and transmits it to the PCRF 2 (803). The “IEEE802.11b” of the Access-Network-Info field 402 of the corresponding entry of the session information table 400 is stored in the Access-Network-Info field 724 of the service information notify packets 720.

Receiving the service information notify packet 720A (803), the PCRF 2 adds a new entry to the service information table 500. The “IEEE802.11b” is stored in the Access-Network-Info field 504 of the corresponding entry in the second embodiment. And the PCRF 2 transmits a service information reply packet to the CSCF 1 as a reply to service information notify packet similarly as in the first embodiment (804). Then, transmitting a SIP PRACK message to the CSCF 1 (805A), the UE device 7 receives a SIP 200 reply message as a reply to the SIP PRACK message (806A).

The UE device 7 starts bearer establishment with the AGW 3A (807). The AGW3A transmits a resource request packet 740 to the PCRF 2 (808).

The PCRF 2 receiving the resource request packet 740 (808) searches for the corresponding entry 500A from the service information table 500 (221 of FIG. 13B). And the PCRF2 searches for the corresponding entry 550B from the access type-QoS information table 550 based on the value “IEEE802.11b” stored in the Access-Network-Info field 504 (223 of FIG. 13B) Then, the PCRF 2 decides whether or not to permit the establishment of a session based on the values stored in the received resource request packet 740A (224-228 of FIG. 13B). In addition, since streaming is not approved when an access type is “IEEE802.11b”, the establishment of a session is refused. The PCRF 2 generates a resource reject packet and transmits it to the AGW 3A (830; 230 of FIG. 13B).

The UE device 7 receives the notice of the disapproval of bearer establishment (831), and transmits a SIP CANCEL message to the CSCF 1 (832) to stop the processing for establishing the session under continuation.

The CSCF 1 transmits the received SIP CANCEL message to a suitable destination (833). Furthermore, the CSCF 1 transmits a SIP 200 reply message to the UE device 7 as a reply to the received SIP CANCEL message (834). The CSCF 1 receives the SIP 200 reply message as a reply to the SIP CANCEL message from the destination (835). And as a reply to the SIP INVITE message, the CSCF 1 receives a SIP 487 reply message (836B), and transmits it to the UE device 7 (836A). Moreover, the CSCF 1 transmits the SIP ACK message to a destination (837). Furthermore, the UE device 7 receiving the SIP 487 reply message transmits the SIP ACK message to the CSCF 1 (838).

According to the second embodiment, a use of the multimedia service that requires a large quantity of resources can be restricted in the case that the UE device 7 is connected to an access type with a low bandwidth. As a result, an undesirable situation can be avoided such that one user monopolizes exclusively a band making other users unable to use any services. Moreover, a entrepreneur is able to provide completely fair and stable services to customers.

### Third Embodiment

The third embodiment is similar to the second embodiment, and the case is explained wherein the UE device 7 is connected to the AP 5B of IEEE802.11b, and to establish a session of the video stream media in the Downlink direction.

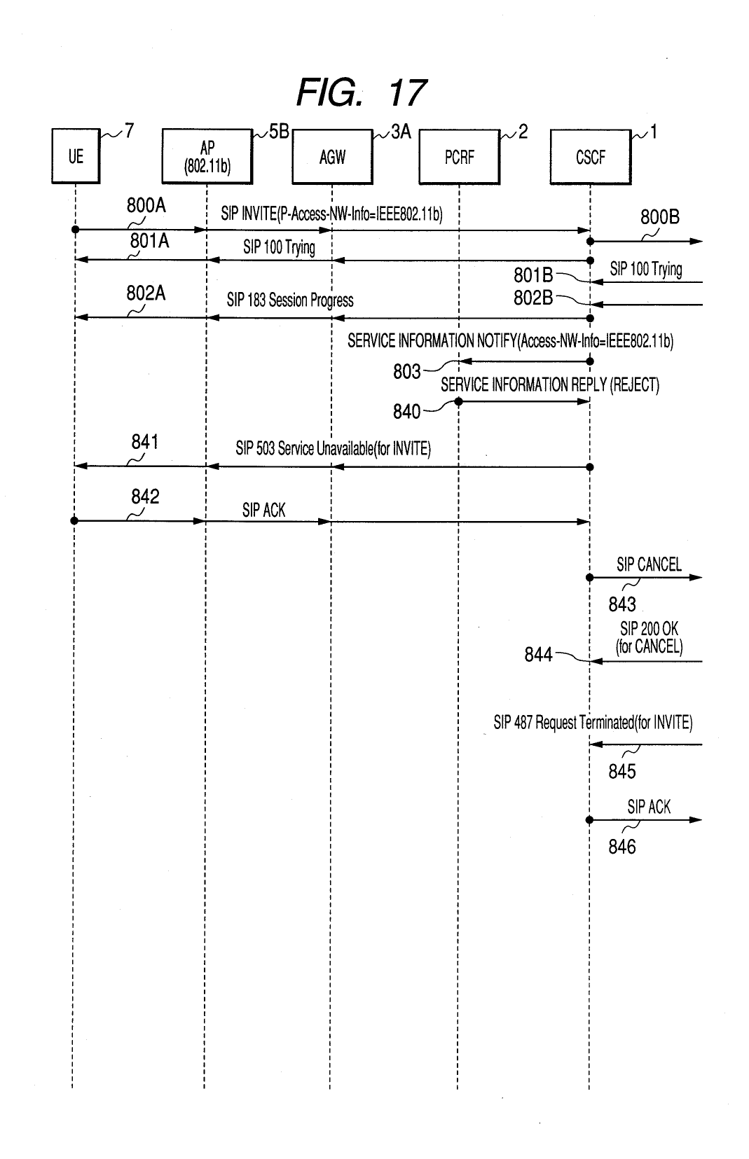

FIG. 17 shows the sequence of processing to establish the session of the image stream media in the Downlink direction from the UE device 7 in the third embodiment. In addition, if the access type-QoS information table 550 shown in FIG. 6B is used, although establishment of this session is unsuccessful, the adapted sequence serves as a different one from that of the second embodiment.

The sequence of transmitting a SIP INVITE message to the CSCF 1 by the UE device 7 (800A) and the one of transmitting a service notify packet to the PCRF 2 by the CSCF (803) in the third embodiment are the same as those in the second embodiment.

The PCRF 2 transmits a service information reply packet to the CSCF 1 as a reply to the service information notify packet 720A (840; 202 of FIG. 13A). The PCRF 2 completing the adding processing of the service information table 500 (201 of FIG. 13A), decides the permission or rejection of the session with reference to the corresponding entry 550C of the access type-QoS information table 550 in the third embodiment. The session is rejected since the streaming is not approved when the corresponding entry 550C of the access type-QoS information table 550 is referred to. The PCRF 2 notifies the CSCF 1 that the session establishment is rejected (840). And the CSCF 1 executes processing for stopping establishment of a session.

The CSCF 1 operates as a B2BUA (Back-To-Back User Agent) in the third embodiment. The CSCF 1 transmits a SIP 503 reply message as a reply to the SIP INVITE message from the UE device 7 (841). The UE device 7 receiving the SIP 503 reply message transmits the ACK message to the CSCF 1 (842).

Then, the CSCF 1 transmits the SIP CANCEL message (843). And the CSCF 1 receives an SIP 200OK reply message as a reply to the SIP CANCEL message (844), and furthermore, receives the SIP 487 reply message as a reply to the SIP INVITE message (845). Then, the CSCF 1 transmits the SIP ACK message to a destination (846).

According to the third embodiment, a use of the multimedia service that requires a large quantity of resources can be restricted in the case that the UE device 7 is connected to an access type with a low band width. As a result, an undesirable situation can be avoided such that one user monopolizes exclusively a band making other users unable to use any services. Moreover, a entrepreneur is able to provide completely fair and stable services to customers.

Furthermore, according to the third embodiment, transmission and reception of messages between devices can be simplified, and a session can be established quickly.

### Fourth Embodiment

In the fourth embodiment, the PCRF 2 decides a QoS policy based on the user ID of the UE device 7 in addition to the type of access of network.

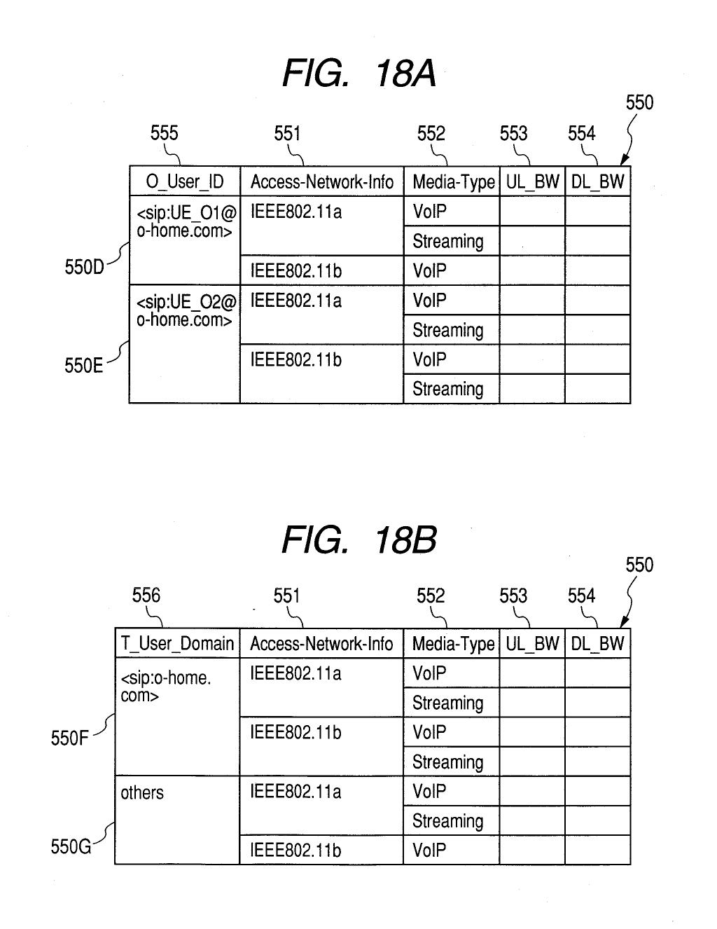

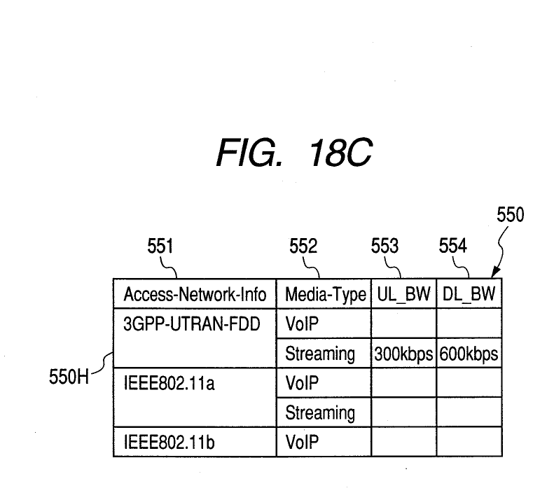

FIG. 18A shows the access type-QoS information table 550 in the fourth embodiment. The access type-QoS information table 550 of FIG. 18A is different from the same one of FIG. 6 in that the former includes the O_User_ID field 555. And when searching the access type-QoS information table 550 (FIG. 13B-223), the QoS policy decision program 220 searches based on not only the Access-Network-Info field 551, but also the O_User_ID field 555 in the fourth embodiment. Therefore, a different QoS policy can be applied to each of different users.

For example, in the access type-QoS information table 550, different entries are set, one is the entry 550D for a user <sip:UE_O1@o-home.com> and the other one is the entry 550E for another user <sip:UE_O2@o-home.com>. Therefore, in the environment of IEEE802.11b, although the user <sip:UE_O1@o-home.com> cannot use an image stream service, the user <sip:UE_02@o-home.com> can use an image stream service.

According to the fourth embodiment, differentiation of a service from others can be attained to every user. For example, it is also possible to differentiate services based on the terms of contract to be acquired from the HSS 8. Moreover, it is also possible to discriminate services depending on whether a user is a contractor of the entrepreneur or a contractor of the entrepreneur who has made a roaming contract.

### Fifth Embodiment

In the fifth embodiment, the PCRF 2 decides a QoS policy based on a partner's domain or the user ID the UE device 7 communicates with, in addition to the type of access of network.

FIG. 18B shows the access type-QoS information table 550 in the fifth embodiment. The access type-QoS information table 550 of FIG. 18B is different from that of FIG. 6B in that that of FIG. 18B includes the T_User_Domain field 556. In the fifth embodiment, when searching the access type-QoS information table 550 (FIG. 13B-223), the QoS policy decision program 220 searches based on not only the Access-Network-Info field 551, but also the T_User_ID field 556. Therefore, a different QoS policy can be applied to each of different users.

For example, in the access type-QoS information table 550, different entries are set, one is the entry 550F for enterprise's domain <sip:o-home.com> and the other the entry 550G for others. Therefore, in the environment of IEEE802.11b, although the image stream service from AS61 (SIP URI<sip:AS1@o-home.com>) is available, the use of the image stream service from AS62 (SIP URI<sip:AS2@t-home.com>) is forbidden. In addition, although it is necessary to notify the domain of the communications partner of the UE device 7 to the PCRF 2 to decide a QoS policy, it may be realized by using the Subscription-ID field 723 included in the service information notify packet 720 to be transmitted to the CSCF 1.

According to the fifth embodiment, a QoS policy can be decided so that it may prevent that the resource of one's company is consumed in large quantities through the use of multimedia services provided by other companies. Moreover, a QoS policy also can be decided so that only the multimedia service provided by one's company may become available.

### Sixth Embodiment

Although in the first to the fifth embodiments the 3GPP2 networks of the present invention are explained, however, in the sixth embodiment the present invention is applied to the 3GPP network itself.

FIG. 18C shows the access type-QoS information table 550 in the sixth embodiment. The access type-QoS information table 550 in the sixth embodiment includes an entry 550H for the wireless access types for 3GPP. The PCRF 2 can decide a QoS policy based on the Entry 550H.

According to the sixth embodiment, the present invention is applicable not only to the 3GPP2 network but also to the 3GPP network.

### Seventh Embodiment

In the seventh embodiment, a different QoS policy is decided for each access point.

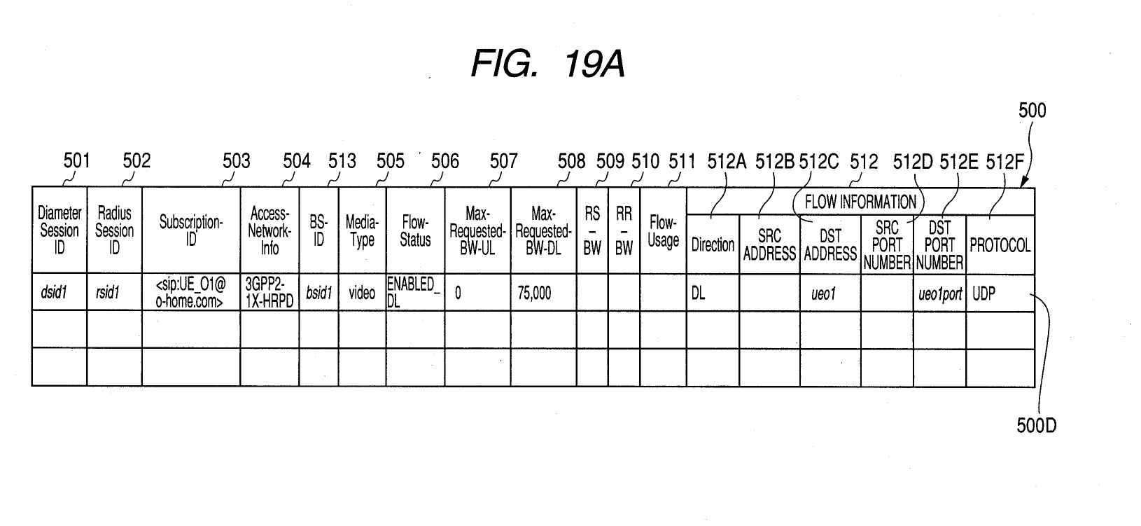

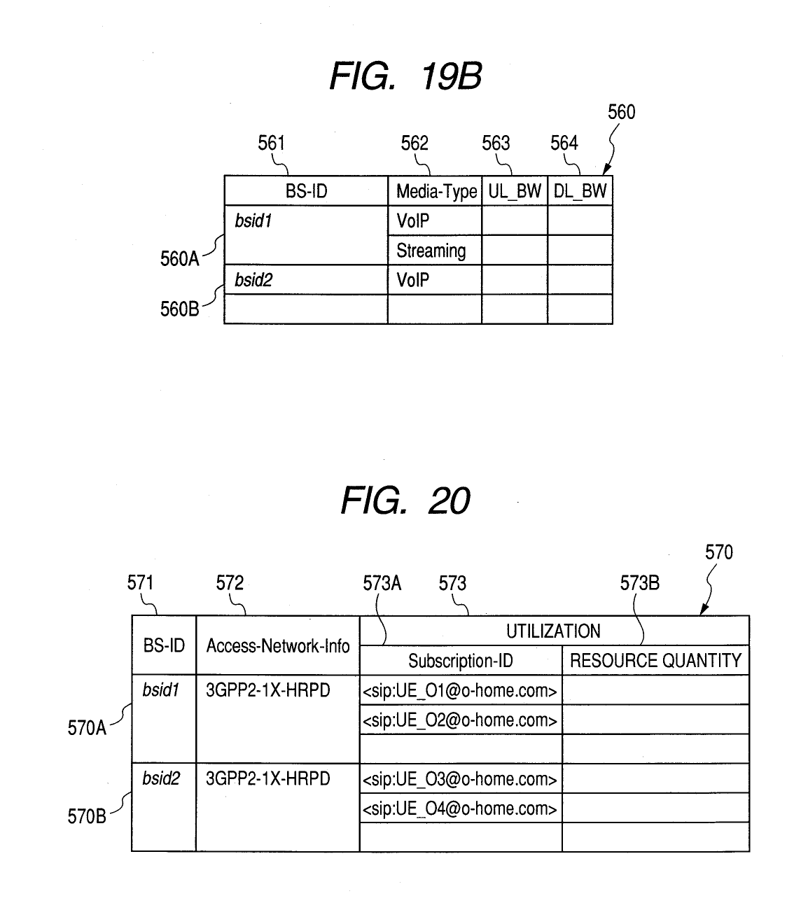

FIG. 19A shows the structure of the service information table 500 in the seventh embodiment. The service information table 500 of FIG. 19A is different from the service information table 500 of FIG. 6A in that the service information table 500 of FIG. 19A includes a BS_ID field 513. The BS_ID field 513 stores the identifier for specifying an access point uniquely (access point ID).

FIG. 19B shows the structure of the access point-QoS information table 560 in the seventh embodiment. The access point QoS information table 560 is stored in the memory 22 of the PCRF 2. The access point-QoS information table 560 is a table to be referred to when the QoS policy decision program 220 decides a QoS policy. The access point-QoS information table 560 is previously set by the entrepreneur who offers an access network.

The access point QoS information table 560 includes a BS-ID field 561, a Media-Type field 562, a UL_BW field 563, and a DL_BW field 564. The BS-ID field 561 stores an access point ID which is an identifier of an access point. The Media-Type field 562 is the same as the Media-Type field 552 in the access type-QoS information table 550. Moreover, the UL_BW field 563 and the DL_BW field 564 are the same as the UL_BW field 553 and the DL_BW field 554 in the access type-QoS information table 550, respectively. In addition, an entry 560A for BS6A (access point ID=bsid1) and an entry 560B for BS6B (access point ID=bsid2) are set in the access point-QoS information table 560 of FIG. 19B.

Then, the processing is described for connecting the UE device 7 to the BS 6A and establishing the session of an image stream in the seventh embodiment. The P-Access-Network-Info header 709 of the SIP INVITE message transmitted by the UE device 7 stores the type of access and access point ID. Specifically, a bsid1 which is an access point ID of BS6A is stored. Furthermore, when the CSCF 1 transmits the service information notify packet 720 to the PCRF 2, the Access-Network-Info field 724 of the packet 720 includes the access point ID (bsid1 in this example).

The PCRF 2 receiving the service information notify packet 720 adds a new entry 500D to the service information table 500, The access point ID in the Access-Network-Info field 724 is stored in the BS-ID field 513 in the seventh embodiment. And the QoS policy decision program 220 searches the access point QoS information table 560 based on the value of BS-ID field 561. Referring to FIG. 19B, the establishment of the session succeeds because an image streaming service is approved when an access point is BS6A (BS-ID=bsid1).

Meanwhile, when the access point the UE device 7 connected thereto is BS6B (access point ID=bsid2), the establishment of the session fails because an image streaming service is not approved referring to the access point-QoS information table 560 of FIG. 19B.

According to the seventh embodiment, a QoS policy can be decided so that a different QoS policy can be applied to each access point a user equipment device is connected thereto. For example, it is also possible to differentiate services by applying different QoS policies between an access point installed in a company and an access point for public.

### Eighth Embodiment

A QoS policy is decided based on the information on each access point usage, such as a traffic quantity actually used in the eighth embodiment. In addition to the structure of the seventh embodiment, the PCRF 2 has an access point utilization situation table 570. The access point utilization situation table 570 is referred to estimating a traffic volume used at each access point. Moreover, as for the access point utilization situation table 570, an entry is dynamically added to the table by the service information management program 200.

FIG. 20 shows the structure of the access point utilization situation table 570 in the 8th embodiment. The access point utilization situation table 570 includes a BS_ID field 571, an Access-Network-Info field 572, and a utilization situation field 573. The utilization situation field 573 includes a Subscription-ID field 573A and a resource quantity field 573B. The BS_ID field 571 stores the access point ID. The Access-Network-Info field 572 stores the type of access of an access point. The utilization situation field 573 stores the utilization situation of an access point. The Subscription-ID field 573A stores a user ID. The resource quantity field 573B stores the resource quantity which a user is using. In addition, an entry 570A for BS6A (access point ID=bsid1) and an entry 570B for BS6B (access point ID=bsid2) are set in this table 570.

The PCRF 2 also adds an entry to the access point utilization situation table 570 based on the information stored in the service information table 500, when updating an entry to the service information table 500 by the service information management program 200 (201 of FIG. 13A). When the QoS policy decision program 220 decides a QoS policy, the QoS policy is decided with reference to the access point utilization situation table 570.

According to the eighth embodiment, a different QoS policy can be decided according to the utilization situation of an access point. For example, a QoS policy can be decided more flexibly in such a way that the use of service consuming a lot of resources is forbidden such as an image streaming when the access point is crowded, whereas the use of service can be approved when the access point is not crowded.

What is claimed is:

1. A QoS (Quality of Service) control system for controlling allocation of resources in a network where a user equipment is linked to a core network providing services via an access network, the QoS control system comprising:
a QoS policy decision server for deciding a QoS policy for a service requested from the user equipment; and
an access gateway for connecting the access network and the core network; wherein the QoS policy decision server decides the QoS policy based on the type of access connecting the user equipment and the access network.

2. The QoS control system according to claim 1, wherein the QoS policy decision server decides a QoS policy to be applied to a path at least included in the access network or to a path adjacent to the path included in the access network.

3. The QoS control system according to claim 1, wherein the QoS policy decision server preserves the correspondence relation of the type of access the user equipment is connected thereto and the QoS policy, and decides a QoS policy with reference to the correspondence relation.

4. The QoS control system according to claim 1, wherein the QoS policy decision server decides a QoS policy based on at least either of the media type or the required band for providing a service to the user equipment.

5. The QoS control system according to claim 1, further comprising a call control server for managing a session used by the user equipment, wherein the QoS policy decision server decides a QoS policy for each individual session.

6. The QoS control system according to claim 1, wherein the call control server informs the QoS policy decision server of the type of access for each individual session.

7. The QoS control system according to claim 1, wherein the QoS policy decision server decides a QoS policy based on at least either of the user identifier or the affiliation domain of the user equipment.

8. The QoS control system according to claim 1, wherein the QoS policy decision server decides a QoS policy based on at least either of the user identifier or the affiliation domain of the partner equipment of that of a user.

9. The QoS control system according to claim 1, wherein the QoS policy decision server decides a QoS policy based on the utilization situation of the user equipment access-type.

10. The QoS control system according to claim 1, wherein the QoS policy decision server decides a QoS policy based on each type of access for the user equipment even though the equipment may have the same IP address and the same port number for the access.

11. A QoS (Quality of Service) control system for controlling allocation of resources in a network where a user equipment is linked to a core network providing services via an access network, the QoS control system comprising:
a QoS policy decision server for deciding a QoS policy for a service requested from the user equipment; and
an access gateway for connecting the access network and the core network; wherein the QoS policy decision server decides the QoS policy based on the identifier of the access point the user equipment is connected.

12. The QoS control system according to claim 11, wherein the QoS policy decision server decides a QoS policy to be applied to a path at least included in the access network or to a path adjacent to the path included in the access network.

13. The QoS control system according to claim 11, wherein the QoS policy decision server preserves the correspondence relation of the identifier of the access point and the QoS policy, and decides a QoS policy with reference to the correspondence relation.

14. The QoS control system according to claim 11, wherein the QoS policy decision server decides a QoS policy based on at least either of the media type or the required band for providing a service to the user equipment.

15. The QoS control system according to claim 11, further comprising a call control server for managing a session used by the user equipment, wherein the QoS policy decision server decides a QoS policy for each individual session.

16. The QoS control system according to claim 15, wherein the call control server informs the QoS policy decision server of the identifier of the access point for each individual session.

17. The QoS control system according to claim 11, wherein the QoS policy decision server decides a QoS policy based on at least either of the user identifier or the affiliation domain of the user equipment.

18. The QoS control system according to claim 11, wherein the QoS policy decision server decides a QoS policy based on at least either of the user identifier or the affiliation domain of the partner equipment of that of a user.

19. The QoS control system according to claim 11, wherein the QoS policy decision server decides a QoS policy based on the utilization situation of the access point.

20. The QoS control system according to claim 11, wherein the QoS policy decision server decides a QoS policy based on each identifier of the access point the user equipment is connected thereto even though the equipment may have the same IP address and the same port number for the access.
